(19) United States
(12) Patent Application Publication
(10) Pub. No.: US 2020/0120605 A1
(43) Pub. Date: Apr. 16, 2020

(54) ACCESS POINT APPARATUS, STATION APPARATUS, AND COMMUNICATION METHOD

(71) Applicant: SHARP KABUSHIKI KAISHA, Sakai City, Osaka (JP)

(72) Inventors: HIROMICHI TOMEBA, Sakai City, Osaka (JP); HIDEO NAMBA, Sakai City, Osaka (JP)

(21) Appl. No.: 16/626,483

(22) PCT Filed: Jun. 21, 2018
(86) PCT No.: PCT/JP2018/023628

§ 371 Date: Dec. 24, 2019

(30) Foreign Application Priority Data
Jun. 29, 2017 (JP) 2017-127239

(51) Int. Cl. H04W 52/02; H04W 74/08

(52) U.S. Cl. CPC H04W 52/0229; H04W 84/12; H04W 74/0808

(57) ABSTRACT

An access point apparatus according to the present invention includes: a transmission RF unit configured to transmit a wireless LAN signal and a wake-up radio signal; a reception RF unit configured to perform a carrier sense; and a controller configured to control a transmit signal and a received signal, in which the controller configures the transmission RF unit to include information that indicates a transmission period of the wake-up radio signal in the wireless LAN signal.

### TECHNICAL FIELD

The present invention relates to an access point apparatus, a station apparatus, and a communication method.

This application claims priority based on JP 2017-127239 filed on Jun. 29, 2017, the contents of which are incorporated herein by reference.

### BACKGROUND ART

In recent years, a radio communication system that includes at least a self-supporting terminal apparatus and a base station apparatus that can be relatively freely used has been advanced in use, and has been used in various applications in various forms including a so-called wireless LAN. In particular, the wireless LAN has low difficulty of introduction, is applicable to both a network form that secures connection to the Internet and a network form that is isolated from the outside, and is used for wide use. Although a communication speed of the wireless LAN was approximately 1 Mbps at the beginning of its spread, the speed increases with advances in technology, and the total throughput of communication data in a base station apparatus exceeds 1 Gbps (NPL 1 and NPL 2).

On the other hand, unlike the wireless LAN, use of a radio communication system that focuses on reducing power consumption of a terminal apparatus rather than increasing the communication speed is also advanced. Examples of such a radio communication system include Bluetooth (registered trademark), ZIGBEE (registered trademark), and the like, and is used mainly in a system that uses a battery as a power source.

As the spread of the wireless LAN progresses, demand for introducing the wireless LAN into an apparatus that uses the battery as the power source increases. Although, in the existing wireless LAN, a power-saving operation for increasing standby time is defined, the only way to reduce the power consumption is to increase the standby time, this means increase in waiting time until communication becomes possible in a case that communication data occur, that is, latency, and causes a significant decrease in user experience.

Accordingly, in recent years, standardizing activities for a communication system are being conducted to achieve low power consumption and reduction of a standby time by using, during the standby time, a radio function that is added into a physical layer of the wireless LAN and operates with lower power (NPL 3).

### CITATION LIST

### Non Patent Literature

NPL 1: IEEE std 802.11-2012

NPL 2: IEEE std 802.11ac-2013

NPL 3: IEEE P802.11, A PAR Proposal for Wake-up radio

### SUMMARY OF INVENTION

### Technical Problem

For standardization of a new communication system, coexistence with existing standards is an important issue. However, the use of a signal waveform of a signal frame handled in the added radio function which is different from that of a signal frame handled in the existing wireless LAN has been studied. Thus, in a case that an existing wireless LAN terminal apparatus is connected to an access point supporting the added radio function, and in a case that the existing wireless LAN terminal apparatus erroneously recognizes the signal frame according to the added radio function, channel access is inefficiently performed, thus causing degradation of frequency efficiency.

An aspect of the present invention has been made in view of the above problem, and an object of the present invention is to disclose an access point apparatus, a station apparatus, and a communication method for preventing occurrence of inefficient channel access caused by erroneous recognition of a signal frame with a different standard.

### Solution to Problem

An access point apparatus, a station apparatus, and a communication method according to an aspect of the present invention for solving the above-described problem are as follows.

(1) That is, an access point apparatus according to an aspect of the present invention is an access point apparatus for connecting and performing radio communication with multiple station apparatuses, the access point apparatus includes: a transmission RF unit configured to transmit a wireless LAN signal and a wake-up radio signal; a reception RF unit configured to perform a carrier sense; and a controller configured to control a transmit signal and a received signal, in which the controller configures the transmission RF unit to include information that indicates a transmission period of the wake-up radio signal in the wireless LAN signal.

(2) Furthermore, the access point apparatus according to an aspect of the present invention is described in the aforementioned (1), in which the controller may configure the transmission RF unit to transmit each of the wireless LAN signal and the wake-up radio signal, by using a different radio channel among radio channels.

(3) Furthermore, the access point apparatus according to an aspect of the present invention is described in the aforementioned (2), in which the controller may configure the transmission RF unit to transmit the wireless LAN signal and the wake-up radio signal, by using adjacent radio channels among radio channels.

(4) Furthermore, the access point apparatus according to an aspect of the present invention is described in the aforementioned (2) or (3), in which the controller may configure information common to Duration information written in an SIG field included in the wireless LAN signal and Duration information written in an SIG field included in the wake-up radio signal

(5) Furthermore, the access point apparatus according to an aspect of the present invention is described in the aforementioned (4), in which in a case that a legacy part including the SIG field is transmitted on a wake-up radio channel at a time of transmitting the wake-up radio signal, the controller may configure, in the SIG field of the legacy part, a signal resulting from phase rotation of a signal including the SIG field included in the wireless LAN signal.

(6) Furthermore, the access point apparatus according to an aspect of the present invention is described in the aforementioned (4), in which the controller may configure, in the wireless LAN signal, a signal resulting from phase rotation of the wake-up radio signal.

(7) Furthermore, the access point apparatus according to an aspect of the present invention is described in the aforementioned (2) or (3), in which the transmission RF unit may simultaneously transmit the wireless LAN signal and the wake-up radio signal, and the controller, prior to transmitting the wireless LAN signal, may use the reception RF unit to perform a carrier sense only during a first prescribed period and a period configured by a random back operation on a radio channel for transmitting the wireless LAN signal, and may perform a carrier sense from a point of time, which is a prescribed second period earlier than a point of time when the first prescribed period and the period configured by the random back-off operation end, on a radio channel for transmitting the wake-up radio signal.

(8) Furthermore, the access point apparatus according to an aspect of the present invention is described in the aforementioned (2) or (3), in which the transmission RF unit may simultaneously use at least two radio channels at the time of a transmission, and in a case of the transmission in which the at least two radio channels are used, the controller may control the transmission RF unit and may switch to at least one of options of whether to transmit the wake-up radio signal on one of the radio channels and transmit the wireless LAN signal on a radio channel other than the one of the radio channels on which the wake-up radio signal has been transmitted, and whether to transmit the wireless LAN signal by using all of the radio channels.

(9) Furthermore, the access point apparatus according to an aspect of the present invention is described in the aforementioned (2) or (3), in which the transmission RF unit may transmit a radio signal including information that indicates a change of a radio channel on which the wake-up radio signal is to be transmitted on the radio channel on which the wake-up radio signal is to be transmitted.

(10) Furthermore, an access point apparatus according to an aspect of the present invention is an access point apparatus for connecting and performing radio communication with multiple station apparatuses, the access point apparatus includes: a transmission RF unit configured to transmit a wireless LAN signal and a wake-up radio signal; a reception RF unit configured to perform a carrier sense; and a controller configured to control a transmit signal and a received signal, in which the controller configures the wake-up radio signal to include a legacy part that uses part of a signal format used by the wireless LAN signal and a WU radio part that uses a modulation scheme for wake-up radio, the WU radio part includes an SIG field and a payload portion, multiple combinations of a modulation scheme and a coding scheme to be used for the payload portion can be used, the SIG field includes information that indicates a combination of the multiple combinations of the modulation scheme and the coding scheme to be used and information of the number of symbols in the payload portion, and a maximum number of a value configured as the number of symbols of the payload portion is configured to be changed based on a value of the information that indicates the combination of the modulation scheme and the coding scheme to be used.

(11) Furthermore, an access point apparatus according to an aspect of the present invention is an access point apparatus for connecting and performing radio communication with multiple station apparatuses, the access point apparatus includes: a transmission RF unit configured to transmit a wireless LAN signal and a wake-up radio signal; a reception RF unit configured to perform a carrier sense; and a controller configured to control a transmit signal and a received signal, in which the controller includes, at a time of transmitting the wake-up radio signal, an SIG field in the wake-up radio signal, the SIG field includes an RATE field, and the transmission RF unit writes, in a case that the wireless LAN signal is transmitted, a value that indicates a transmission rate of 6 Mbps in the RATE field, and writes, in a case that the wake-up radio signal is transmitted, a value that indicates a transmission rate other than 6 Mbps in the RATE field.

(12) Furthermore, a station apparatus according to an aspect of the present invention is a station apparatus for connecting and performing radio communication with an access point apparatus, the station apparatus includes: a reception RF unit configured to include a function to receive a wireless LAN signal and a wake-up radio signal, and a function to perform a carrier sense; and a controller configured to control a transmit signal and a received signal, in which the controller controls the reception RF unit to change, in a case that the wake-up radio signal addressed to the station apparatus is received, a radio channel on which the carrier sense is performed to a radio channel on which the wireless LAN signal is received.

(13) Furthermore, the station apparatus according to an aspect of the present invention is described in the aforementioned (12), in which the reception RF unit may receive, from the access point apparatus, a signal including information for indicating that the radio channel on which the wake-up radio signal is transmitted is to be changed, and the controller may control the reception RF unit to change, based on the information for indicating that the radio channel is to be changed, a radio channel that starts a reception operation to receive the wake-up radio signal.

(14) Furthermore, a communication method according to an aspect of the present invention is a communication method of an access point apparatus for connecting and performing radio communication with multiple station apparatuses, the communication method includes the steps of: transmitting a wireless LAN signal and a wake-up radio signal; receiving to perform a carrier sense; and controlling a transmit signal and a received signal, in which, in the controlling, the transmitting is configured to include information that indicates a transmission period of the wake-up radio signal in the wireless LAN signal.

### Advantageous Effects of Invention

According to an aspect of the present invention, an access point apparatus, a station apparatus, and a communication method for preventing occurrence of inefficient channel access caused by erroneous recognition of a signal frame with a different standard are provided, making it possible to contribute to improvement of user throughput of a wireless LAN device.

### BRIEF DESCRIPTION OF DRAWINGS

FIG. 1 is a diagram illustrating an apparatus configuration example according to an embodiment of the present invention.

FIG. 2 is a diagram illustrating a PPDU configuration of the IEEE802.11ac standard.

FIG. 3 is a diagram illustrating an example of L-SIG Dulation.

FIG. 4 is a diagram illustrating an example of frequency resource division according to an embodiment of the present invention.

FIG. 5 is a diagram illustrating an example of a configuration of a PPDU according to an embodiment of the present invention.

FIG. 6 is a diagram illustrating an example of frame transmission according to an embodiment of the present invention.

FIG. 7 is a diagram illustrating a configuration example of a WU radio frame according to an embodiment of the present invention.

FIG. 8 is a diagram illustrating an example of channel access according to an embodiment of the present invention.

FIG. 9 is a diagram illustrating allocation examples of a WU radio channel according to an embodiment of the present invention.

FIG. 10 is a flowchart illustrating an overview of an operation of a station according to an embodiment of the present invention.

FIG. 11 is a diagram illustrating a sequence chart illustrating an operation overview according to an embodiment of the present invention.

FIG. 12 is a block diagram illustrating an example of a configuration of a station used in an embodiment of the present invention.

FIG. 13 is a block diagram illustrating an example of a configuration of a station used in an embodiment of the present invention.

FIG. 14 is a diagram illustrating examples of a configuration of a WU radio signal used in an embodiment of the present invention.

FIG. 15 is a diagram illustrating examples of a configuration of a WU radio frame used in an embodiment of the present invention.

### DESCRIPTION OF EMBODIMENTS

Hereinafter, a radio communication technology according to embodiments of the present invention will be described in detail with reference to the drawings.

A communication system according to the present embodiment includes a radio transmission device (Access point, Base station apparatus, Access point apparatus), and multiple radio reception devices (Stations, Terminal apparatuses, Station apparatuses). Furthermore, a network including the base station apparatus and the terminal apparatus is referred to as a Basic service set (BSS, management range). Furthermore, the base station apparatus and the terminal apparatus are also collectively referred to as a radio apparatus. The terminal apparatus can include a function included in the base station apparatus.

Each of the base station apparatus and the terminal apparatus in the BSS is assumed to perform communication based on Carrier sense multiple access with collision avoidance (CSMA/CA). A target of the present embodiment is an infrastructure mode in which the base station apparatus communicates with multiple terminal apparatuses, but the method of the present embodiment can also be implemented in an ad hoc mode in which the terminal apparatuses perform direct communication with each other. In the ad hoc mode, the terminal apparatus replaces the base station apparatus and forms the BSS. The BSS in the ad hoc mode is also referred to as an Independent Basic Service Set (IBSS). Hereinafter, the terminal apparatus forming the IBSS in the ad hoc mode can also be regarded as the base station apparatus.

In the IEEE802.11 system, each apparatus can transmit transmission frames of multiple frame types with a common frame format. The transmission frames are individually defined in a Physical (PHY) layer, a Medium access control (MAC) layer, and a Logical Link Control (LLC) layer.

The transmission frame of the PHY layer is referred to as a physical protocol data unit (PHY protocol data unit (PPDU), physical layer frame). The PPDU includes a physical layer header (PHY header) including header information for performing signal processing in the physical layer and the like, a physical service data unit (PHY service data unit (PSDU)) which is a data unit processed in the physical layer, and the like. The PSDU can include an Aggregated MPDU (A-MPDU) in which multiple MAC protocol data units (MPDUs) to serve as a retransmission unit in a radio section are aggregated.

The PHY header includes a reference signal such as a Short training field (STF) used for detection, synchronization, or the like of a signal, a Long training field (LTF) used for obtaining channel information for data demodulation, or the like, and a control signal such as a Signal (SIG) including control information for data demodulation or the like. Furthermore, the STF is classified, in accordance with a corresponding standard, into a Legacy-STF (L-STF), a High throughput-STF (HT-STF), a Very high throughput-STF (VHT-STF), a High efficiency-STF (HE-STF), and the like. The LTF and the SIG are also respectively classified, in the same manner as the STF, into an L-LTF, an HT-LTF, a VHT-LTF, and an HE-LTF, and into an L-SIG, an HT-SIG, a VHT-SIG, and an HE-SIG. The VHT-SIG is further classified into a VHT-SIG-A1, a VHT-SIG-A2, and a VHT-SIG-B. In the same manner, the HE-SIG is classified into HE-SIG-A1 to 4 and an HE-SIG-B.

Furthermore, the PHY header can include information for identifying the BSS of a transmission source of the transmission frame (hereinafter, also referred to as BSS identification information). The information for identifying the BSS can be, for example, a Service Set Identifier (SSID) of the BSS or a MAC address of the base station apparatus of the BSS. Furthermore, the information for identifying the BSS can be a BSS specific value (e.g., BSS Color, or the like) other than the SSID and the MAC address.

The PPDU is modulated in accordance with the supporting standard. For example, in a case of the IEEE802.11n standard, modulation to the Orthogonal frequency division multiplexing (OFDM) signal is performed. For example, in a case of the IEEE802.11ad standard, modulation to a single carrier signal can also be performed.

The MPDU includes an MAC layer header (MAC header) including header information for performing signal processing in the MAC layer and the like, an MAC service data unit (MSDU), which is a data unit processed in the MAC layer, or a frame body, and a frame check unit (Frame check sequence (FCS)) for checking whether or not the frame contains errors. Furthermore, multiple MSDUs can also be aggregated as an Aggregated MSDU (A-MSDU).

Frame types of the MAC layer transmission frame are roughly classified into three frames of a management frame for managing an association state between the apparatuses or the like, a control frame for managing a communication state between the apparatuses, and a data frame including actual transmission data, and each type is further classified into multiple subframe types. The control frame includes a reception completion notification (Acknowledge (Ack)) frame, a transmission request (Request to send (RTS)) frame, a reception preparation completion (Clear to send (CTS)) frame, and the like. The management frame includes a Beacon frame, a Probe request frame, a Probe response frame, an Authentication frame, an Association request frame, an Association response frame, and the like. The Data frame includes a Data frame, a polling (CF-poll) frame, and the like. By reading contents of a frame control field included in the MAC header, each apparatus can obtain the frame type and the subframe type of the received frame.

Note that the Ack may include a Block Ack. The Block Ack is capable of performing a reception completion notification for the multiple MPDUs.

The beacon frame includes a Field in which a cycle in which the beacon is transmitted (Beacon interval) and the SSID are written. The base station apparatus can cyclically broadcast the beacon frame in the BSS, and the terminal apparatus can grasp, by receiving the beacon frame, the base station apparatus around the terminal apparatus. Grasping the base station apparatus by the terminal apparatus based on the beacon frame broadcast by the base station apparatus is referred to as Passive scanning. On the other hand, probing the base station apparatus by the terminal apparatus that broadcasts the probe request frame in the BSS is referred to as Active scanning. The base station apparatus can transmit the probe response frame as a response to the probe request frame, and the contents written in the probe response frame is equivalent to that of the beacon frame.

After recognizing the base station apparatus, the terminal apparatus performs association processing on the base station apparatus. The association processing is classified into an Authentication procedure and an Association procedure. The terminal apparatus transmits an authentication frame (authentication request) to a base station apparatus with which the terminal apparatus desires to establish the association. In a case of receiving the authentication frame, the base station apparatus transmits, to the terminal apparatus, the authentication frame (authentication response) including a status code indicating whether or not the authentication is allowed for the terminal apparatus or the like. The terminal apparatus can determine whether or not the authentication of the apparatus itself is allowed by the base station apparatus by reading the status code written in the authentication frame. Note that the base station apparatus and the terminal apparatus are capable of exchanging authentication frames multiple times.

Following the authentication procedure, the terminal apparatus transmits an association request frame in order to perform an association procedure to the base station apparatus. In a case of receiving the association request frame, the base station apparatus determines whether or not to allow the association of the terminal apparatus, and transmits the association response frame for notification of the determination. In the association response frame, in addition to the status code indicating whether or not the association process is allowed, an association identification number (Association identifier (AID)) for identifying the terminal apparatus is written. The base station apparatus can manage the multiple terminal apparatuses by configuring different AID for each terminal apparatus whose association therewith has been allowed.

After the association processing is performed, the base station apparatus and the terminal apparatus perform actual data transmission. In the IEEE802.11 system, a Distributed Coordination Function (DCF) and a Point Coordination Function (PCF), and expanded functions of these (Enhanced distributed channel access (EDCA), Hybrid coordination function (HCF), and the like) are defined. Descriptions will be given below by taking a case that the base station apparatus transmits a signal to the terminal apparatus by the DCF as an example.

In the DCF, prior to communication, the base station apparatus and the terminal apparatus perform Carrier sense (CS) for confirming a use situation of a radio channel around the apparatus itself. For example, in a case of receiving a signal with a higher level than a predetermined Clear channel assessment level (CCA level) on the radio channel, the base station apparatus, which is the transmission station, postpones the transmission of the transmission frame on the radio channel. Hereinafter, in the radio channel, a state in which a signal with the CCA level or higher is detected is referred to as a Busy state, and a state in which no signal with the CCA level or higher is detected is referred to as an Idle state. As described above, the CS performed based on power (received power level) of the signal actually received by each apparatus is referred to as physical carrier sense (physical CS). Note that the CCA level is also referred to as a carrier sense level (CS level) or a CCA threshold (CCAT). Note that in a case of detecting the signal with the CCA level or higher, the base station apparatus and the terminal apparatus enter into an operation of demodulating at least the signal of the PHY layer. Accordingly, the carrier sense level can also be considered as minimum reception power (minimum reception sensitivity) at which the base station apparatus and the terminal apparatus can correctly demodulate the received frame.

The base station apparatus performs the carrier sense only in an Inter frame space (IFS) depending on the type on the transmission frame to be transmitted, and determines whether the radio channel is in the busy state or the idle state. The duration during which the base station apparatus performs the carrier sense differs depending on the frame type and the subframe type of the transmission frame which will be transmitted by the base station apparatus. In the IEEE802.11 system, multiple IFSs with different durations are defined, and examples of the multiple IFSs include a short inter frame space (Short IFS (SIFS)) used for a transmission frame with the highest priority given, a polling inter frame space (PCF IFS (PIFS)) used for a transmission frame with a relatively high priority, a distributed control inter frame space (DCF IFS (DIFS)) used for a transmission frame with the lowest priority, and the like. The IFS used for the transmission frame with the high priority is shorter in duration, and for example, the SIFS can be configured to 16 us, the PIFS can be configured to 25 us, and the DIFS can be configured to 34 us. In a case that the base station apparatus transmits a data frame by the DCF, the base station apparatus uses the DIFS. Note that in the EDCA, an Arbitration interframe space (Arbitration IFS (AIFS)) is available, and in the AIFS, for each Access category (AC) configured for the frame to be transmitted by the base station apparatus, a different duration can be configured, and the frame priority can be further flexibly configured.

After standing by for the DIFS, the base station apparatus further stands by for a random back-off time to prevent a frame collision. In the IEEE802.11 system, a random back-off time which is called a Contention window (CW) is used. In the CSMA/CA, it is assumed that the transmission frame transmitted by a certain transmission station is received by a reception station in a state where there is no interference from other transmission stations. Accordingly, in a case that the transmission stations transmit the transmission frames at the same timing, the frames collide with each other, and cannot be correctly received by the reception station. Therefore, by each of the transmission stations standing by for a time which is randomly configured before starting the transmission, the frame collision is avoided. In a case of determining that the radio channel is in the idle state by the carrier sense, the base station apparatus starts a countdown of the CW, acquires the transmission right for the first time after the CW reaches 0, and can transmit the transmission frame to the terminal apparatus. Note that in a case that the base station apparatus determines that the radio channel is in the busy state by the carrier sense during the countdown of the CW, the countdown of the CW is stopped. Then, in a case that the radio channel enters the idle state, following the previous IFS, the base station apparatus resumes the countdown of the remaining CW.

The terminal apparatus, which is the reception station, receives the transmission frame, reads the PHY header of the transmission frame, and demodulates the received transmission frame. Then, by reading the MAC header of the demodulated signal, the terminal apparatus can recognize whether or not the transmission frame is a frame addressed to the apparatus itself. Note that the terminal apparatus can determine the destination of the transmission frame based on information written in the PHY header (e.g., a group identification number (Group identifier (GID), Group ID) in which the VHT-SIG-A is written).

In a case that the received transmission frame is determined as being addressed to the apparatus itself and the transmission frame has been able to be demodulated without errors, it is necessary for the terminal apparatus to transmit the ACK frame indicating that the frame can be correctly received to the base station apparatus, which is the transmission station. The ACK frame is one of the transmission frames with the highest priority transmitted only by standing by during the SIFS duration (random back-off time is not taken). The base station apparatus terminates a series of communications in a case of receiving the ACK frame transmitted from the terminal apparatus. Note that in a case that the terminal apparatus has not been able to correctly receive the frame, the terminal apparatus does not transmit the ACK. Accordingly, in a case that the ACK frame is not received from the reception station for a constant duration (SIFS+ACK frame length) after transmitting the frame, the base station apparatus considers the communication as a failure and terminates the communication. As described above, the termination of one-time communication (also referred to as a burst) of the IEEE802.11 system is always determined by the presence or absence of the reception of the ACK frame, except for a special case such as a case of transmission of a broadcast signal such as the beacon frame or the like, a case where fragmentation is used to divide the transmission data, or the like.

The terminal apparatus configures, in a case of determining that the received transmission frame is not a frame addressed to the apparatus itself, a Network allocation vector (NAV) based on a Length of the transmission frame written in the PHY header or the like. The terminal apparatus does not attempt communication for a duration configured to the NAV. In other words, since the terminal apparatus performs the same operation as that in a case of determining that the radio channel is in the busy state by the physical CS in the duration configured to the NAV, communication control by the NAV is also referred to as virtual carrier sense (virtual CS). The NAV is also configured, in addition to a case of being configured based on the information written in the PHY header, by the transmission request (Request to send (RTS)) frame introduced to solve a hidden terminal problem or by the reception preparation completion (Clear to send (CTS)) frame.

In contrast to the DCF in which each apparatus performs the carrier sense and autonomously acquires the transmission right, in the PCF, a control station called a Point coordinator (PC) controls the transmission right of each apparatus in the BSS. In general, the base station apparatus serves as the PC and acquires the transmission right of the terminal apparatus in the BSS.

A communication period by the PCF includes a Contention free period (CFP) and a Contention period (CP). During the CP, communication is performed based on the DCF as described above, and the PC controls the transmission right during the CFP. The base station apparatus, which is the PC, broadcasts the beacon frame in which the duration of the CFP (CFP Max duration) or the like is written, in BSS, prior to PCF communication. Note that the PIFS is used for the transmission of the beacon frame broadcast at the time of the start of the transmission of the PCF, and transmission is performed without waiting for the CW. The terminal apparatus that has received the beacon frame configures the duration of the CFP written in the beacon frame to the NAV. Thereafter, until the period configured in the NAV elapses or a signal for broadcasting the termination of the CFP in the BSS (e.g., a data frame including a CF-end) is received, the terminal apparatus can acquire the transmission right only in a case that a signal for signalling the transmission right acquisition transmitted from the PC (e.g., a data frame including the CF-poll) is received. Note that during the CFP, since collision of packets within the same BSS does not occur, each terminal apparatus does not take the random back-off time used in the DCF.

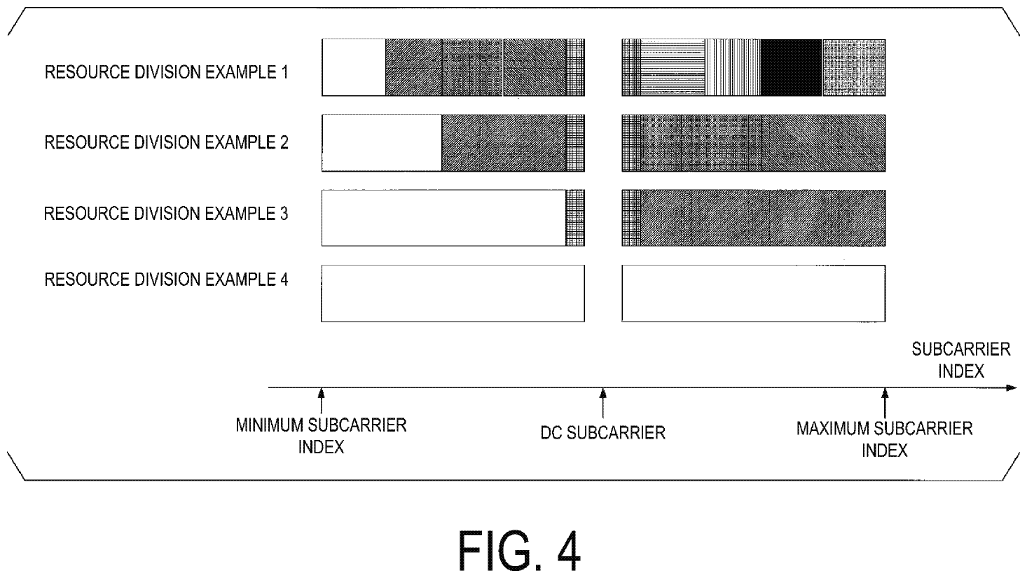

A radio medium can be divided into multiple Resource units (RUs). FIG. 4 is a schematic diagram illustrating examples of a divided state of the radio medium. For example, in a resource division example 1, the radio communication apparatus can divide a frequency resource (subcarrier), which is the radio medium, into nine RUs. In the same manner, in a resource division example 2, the radio communication apparatus can divide the subcarrier, which is the radio medium, into five RUs. As a matter of course, the resource division examples illustrated in FIG. 4 are merely examples, and for example, each of the multiple RUs can include a different number of subcarriers. Furthermore, the radio medium divided as RU can include not only the frequency resource but also a spatial resource. By allocating frames addressed to different terminal apparatuses to the respective RUs, the radio communication apparatus (e.g., AP) can transmit frames to multiple terminal apparatuses (e.g., multiple STAs) at the same time. The AP can write information (Resource allocation information) indicating the state of the division of the radio medium, as common control information, in the PHY header of the frame transmitted by the apparatus itself. Furthermore, the AP can write information (resource unit assignment information) indicating the RU in which the frame addressed to each STA is allocated, as specific control information, in the PHY header of the frame transmitted by the apparatus itself.

In addition, multiple terminal apparatuses (e.g., multiple STAs) can transmit frames at the same time by allocating the frames to the assigned RU, respectively, and transmitting. After receiving a frame (Trigger frame (TF)) including trigger information transmitted from the AP, the multiple STAs can perform frame transmission after standing by for a prescribed duration. Each STA can grasp the RU assigned to the apparatus itself based on the information written in the TF. Furthermore, each STA can acquire the RU by random access using the TF as reference.

The AP can simultaneously assign multiple RUs to one STA. The multiple RUs can include continuous subcarriers or can include discontinuous subcarriers. The AP can transmit one frame using the multiple RUs assigned to one STA, or can transmit the multiple frames by assigning them to different RUs, respectively. At least one of the multiple frames can be a frame including control information common to the multiple terminal apparatuses to which the Resource allocation information is transmitted.

To one STA, multiple RUs can be assigned by the AP. The STA can transmit one frame using the assigned multiple RUs. Furthermore, using the assigned multiple RUs, the STA can transmit the multiple frames by assigning them to different RUs, respectively. The multiple frames can be frames of different frame types.

The AP can assign multiple Associate IDs (AIDs) to one STA. The AP can respectively assign RUs to the multiple AIDs assigned to the one STA. The AP can respectively transmit different frames, using the respectively assigned RUs, to the multiple AIDs assigned to the one STA. The different frames can be frames of different frame types.

To the one STA, the multiple Associate IDs (AIDs) can be assigned by the AP. To the multiple AIDs assigned to the one STA, RUs can be assigned, respectively. The one STA can recognize all the RUs respectively assigned to the multiple AIDs assigned to the apparatus itself as RUs assigned to the apparatus itself and can transmit one frame using the assigned multiple RUs. Furthermore, the one STA can transmit multiple frames using the assigned multiple RUs. At this time, the multiple frames can be transmitted with information, written therein, indicating the AIDs associated with the RUs respectively assigned thereto. The AP can respectively transmit different frames, using the respectively assigned RUs, to the multiple AIDs assigned to the one STA. The different frames can be frames of different frame types.

Hereinafter, the base station apparatus and the terminal apparatus are also collectively referred to as a radio communication apparatus. Furthermore, information exchanged in a case that a certain radio communication apparatus communicates with another radio communication apparatus is also referred to as data. That is, the radio communication apparatus includes a base station apparatus and a terminal apparatus.

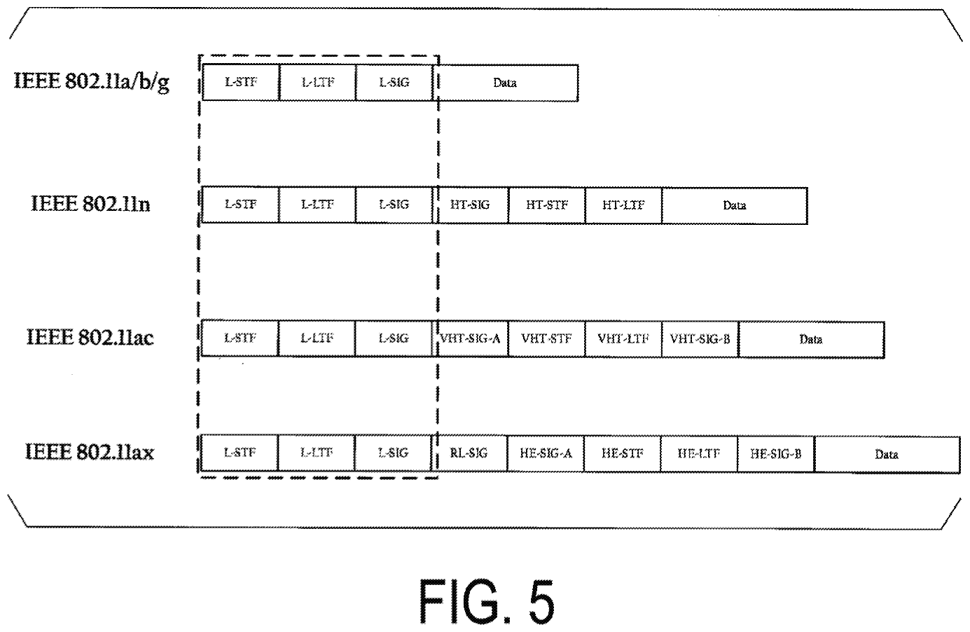

The radio communication apparatus includes any one or both of a transmission function and a reception function of the PPDU. FIG. 5 is a diagram illustrating examples of a configuration of the PPDU transmitted by the radio communication apparatus. The PPDU supporting the IEEE802.11a/b/g standards has a configuration that includes the L-STF, the L-LTF, the L-SIG, and a Data frame (MAC Frame, payload, data part, data, information bit, and the like). The PPDU supporting the IEEE802.11n standard has a configuration that includes the L-STF, the L-LTF, the L-SIG, the HT-SIG, the HT-STF, the HT-LTF, and a Data frame. The PPDU supporting the IEEE802.11ac standard has a configuration that includes some or all of the L-STF, the L-LTF, the L-SIG the VHT-SIG-A, the VHT-STF, the VHT-LTF, the VHT-SIG-B, and the MAC frame. The PPDU being discussed in the IEEE802.11ax standard has a configuration that includes some or all of the L-STF, L-LTF, L-SIG, RL-SIG in which the L-SIG is repeated in terms of time, the HE-SIG-A, the HE-STF, the HE-LTF, the HE-SIG-B, and a Data frame.

The L-STF, the L-LTF, and the L-SIG, which are surrounded by dotted lines in FIG. 5, correspond to a configuration commonly used in the IEEE802.11 standard (hereinafter, the L-STF, the L-LTF, and the L-SIG are collectively referred to as an L-header). That is, for example, a radio communication apparatus supporting the IEEE 802.11a/b/g standards can appropriately receive the L-header in the PPDU supporting the IEEE802.11n/ac standards. A radio communication apparatus supporting the IEEE 802.11a/b/g standards can receive the PPDU supporting the IEEE802.11n/ac standards while regarding it as the PPDU supporting the IEEE 802.11a/b/g standards.

However, the radio communication apparatus supporting the IEEE 802.11a/b/g standards cannot demodulate the PPDU supporting the IEEE802.11n/ac standards subsequent to the L-header, and thus cannot demodulate information relating to a Transmitter Address (TA), a Receiver Address (RA), and a Duration/ID field used for configuration of the NAV.

As a method for the radio communication apparatus supporting the IEEE 802.11a/b/g standards to appropriately configure the NAV (or perform a reception operation for a prescribed duration), the IEEE802.11 defines a method of inserting Duration information into the L-SIG. Information relating to a transmission rate in the L-SIG (RATE field, L-RATE field, L-RATE, L_DATARATE, L_DATARATE field) and information relating to the transmission duration (LENGTH field, L-LENGTH field, L-LENGTH) are used by the radio communication apparatus supporting the IEEE 802.11a/b/g standards to appropriately configure the NAV.

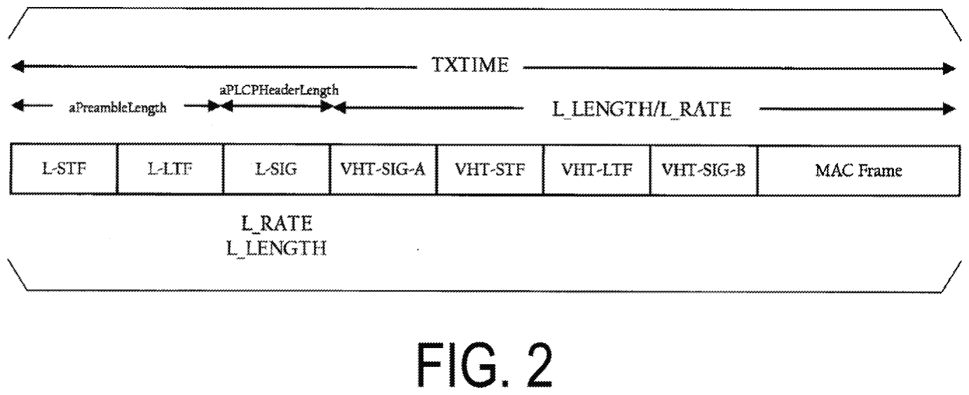

FIG. 2 is a diagram illustrating an example of a relationship between the Duration information to be inserted into the L-SIG and the PPDU configuration. In FIG. 2, although the PPDU configuration supporting the IEEE802.11ac standard is illustrated as an example, the PPDU configuration is not limited thereto. The PPDU configuration supporting the IEEE802.11n standard and the PPDU configuration supporting the IEEE802.11ax standard may be used. TXTIME includes information relating to the length of the PPDU, aPreambleLength includes information relating to the length of a preamble (L-STF+L-LTF), and aPLCPHeaderLength includes information relating to the length of a PLCP header (L-SIG). Equation (1) below is a mathematical expression illustrating an example of a calculation method for L_LENGTH.

$$\begin{matrix}Equation 1 & \\ L\_LENGTH = ⌈ \frac{( \begin{matrix}( TXTIME - SignalExtension ) - \\ ( aPreambleLength + aPLCPHeaderLength )\end{matrix} )}{aSymbolLength} ⌉ \times {N}_{ops} - ⌈ \frac{aPLCPServiceLength + aPLCPConvolutionalTaiLength}{8} ⌉ & ( 1 )\end{matrix}$$

Here, Signal Extension is, for example, a virtual duration configured for compatibility with the IEEE802.11 standard, and Nₒₚₛ indicates information relating to L_RATE. aSymbolLength is information relating to a duration of one symbol (symbol, OFDM symbol, or the like), aPLCPServiceLength indicates the number of bits included in a PLCP Service field, and aPLCPConvolutionalTailLength indicates the number of tail bits of a convolutional code. The radio communication apparatus can calculate the L_LENGTH using Equation (1), for example, and insert the result into the L-SIG. Note that the calculation method for L_LENGTH is not limited to Equation (1). For example, the L_LENGTH can be calculated in accordance with Equation (2) below.

$$\begin{matrix}Equation 2 & \\ L\_LENGTH = ⌈ \frac{( ( TXTIME - SignalExtention ) - 20 )}{4} ⌉ \times 3 - 3 & ( 2 )\end{matrix}$$

In a case that the radio communication apparatus transmits the PPDU by L-SIG TXOP Protection, the L_LENGTH is calculated in accordance with Equation (3) below or Equation (4) below.

$$\begin{matrix}Equation 3 & \\ L\_LENGTH = ⌈ \frac{( \begin{matrix}( L - SIGDuration - SignalExtension ) - \\ ( aPreambleLength + aPLCPHeaderLength )\end{matrix} )}{aSymbolLength} ⌉ \times {N}_{ops} - ⌈ \frac{aPLCPServiceLength + aPLCPConvolutionalTaiLength}{8} ⌉ & ( 3 ) \\ Equation 4 & \\ L\_LENGTH = ⌈ \frac{( ( L - SIGDuration - SignalExtension ) - 20 )}{4} ⌉ \times 3 - 3 & ( 4 )\end{matrix}$$

Here, L-SIG Duration indicates information relating to the PPDU including the L_LENGTH calculated in accordance with, for example, Equation (3) or Equation (4) and a duration obtained by summing durations of the Ack and the SIFS, which are expected to be transmitted from the destination radio communication apparatus as a response thereto. The radio communication apparatus calculates the L-SIG Duration in accordance with Equation (5) below or Equation (6) below.

Equation 5

L−SIGDuration=(T_{init_PPDU}−(aPreambleLength+aPLCPHeaderLength))+SIFS+T_{Res_PPDU} (5)

Equation 6

L−SIGDuration=(T_{MACDur}−SIFS−(aPreambleLength+aPLCPHeaderLength)) (6)

Here, T_{init_PPDU} indicates information relating to the duration of the PPDU including the L_LENGTH calculated in accordance with Equation (5), and the T_{Res_PPDU} indicates information relating to the duration of the PPDU of a response expected for the PPDU including the L_LENGTH calculated in accordance with Equation (5). Additionally, T_{MACDur} indicates information relating to a value of the Duration/ID field included in the MAC frame in the PPDU including the L_LENGTH calculated in accordance with Equation (6). In a case that the radio communication apparatus is an Initiator (starter, sender, leader, Transmitter), the L_LENGTH is calculated in accordance with Equation (5), and in a case that the radio communication apparatus is a Responder (answerer, recipient, Receiver), the L_LENGTH is calculated in accordance with Equation (6).

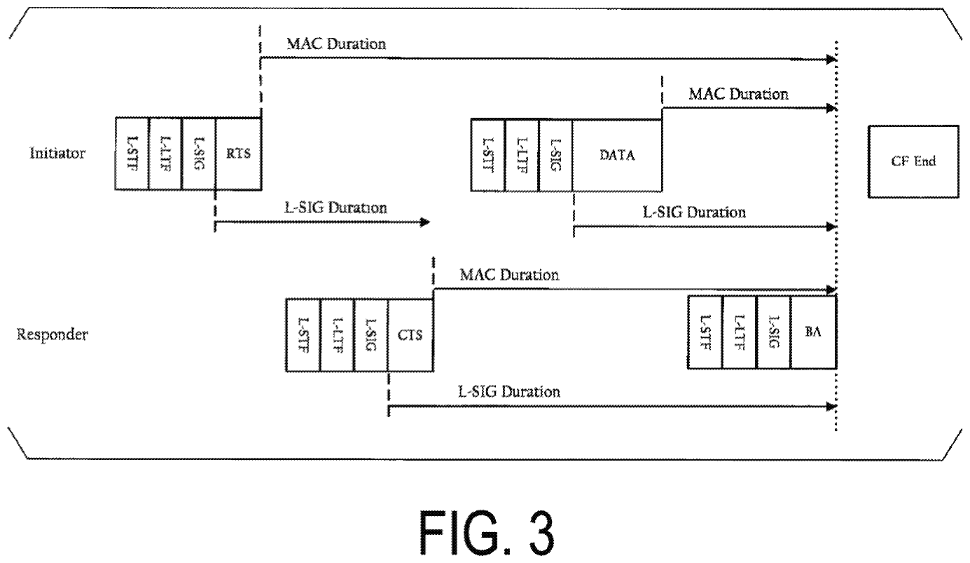

FIG. 3 is a diagram illustrating an example of the L-SIG Duration in the L-SIG TXOP Protection. DATA (frame, payload, data, or the like) includes one of or both the MAC frame and the PLCP header. Additionally, BA is the Block Ack or the Ack. The PPDU can be constituted by including the L-STF, the L-LTF, and the L-SIG, and further including any of or multiple of the DATA, the BA, the RTS, and the CTS. Although the example illustrated in FIG. 3 indicates the L-SIG TXOP Protection using the RTS/CTS, CTS-to-Self may be used. Here, the MAC Duration is a duration indicated by the value of the Duration/ID field. Additionally, the Initiator can transmit a CF_End frame to perform notification of the end of the duration of the L-SIG TXOP Protection.

Next, a method for identifying the BSS from a frame received by the radio communication apparatus will be described. In order for the radio communication apparatus to identify the BSS from the received frame, it is preferable for the radio communication apparatus that transmits the PPDU to insert information (BSS color, BSS identification information, BSS specific value) for identifying the BSS in the PPDU. The information indicating the BSS color can be written in the HE-SIG-A.

The radio communication apparatus can transmit the L-SIG multiple times (L-SIG Repetition). For example, the reception-side radio communication apparatus receives the L-SIG to be transmitted multiple times using Maximum Ratio Combining (MRC), whereby demodulation accuracy of the L-SIG is improved. Furthermore, in a case that the radio communication apparatus successfully completes the reception of the L-SIG by the MRC, it is possible to interpret the PPDU including the L-SIG as a PPDU supporting the IEEE802.11ax standard.

The radio communication apparatus can perform, also during reception operation of a PPDU, a reception operation of a part of a PPDU other than the PPDU (e.g., the preamble, the L-STF, the L-LTF, the PLCP header, or the like defined by the IEEE802.11) (also referred to as duplex receive operation). In a case of detecting, during the reception operation of the PPDU, a part of a PPDU other than the PPDU, the radio communication apparatus can update part of or the entire information relating to a destination address, a transmission source address, and a duration of the PPDU or the DATA.

The Ack and the BA can also be referred to as responses (response frames). Furthermore, probe response, authentication response, and association response can be referred to as response.

The radio communication apparatus includes at least some of the functions described above. In other words, the AP and the STA include a common function. For example, the AP can transmit a frame to the STA as a radio transmission device, but as a matter of course, the STA can also transmit a frame to the AP as a radio transmission device. That is, the STA can include at least some of the functions for transmitting a frame included in the AP. In the same manner, the AP can include at least some of the functions for receiving a frame included in the STA.

### First Embodiment

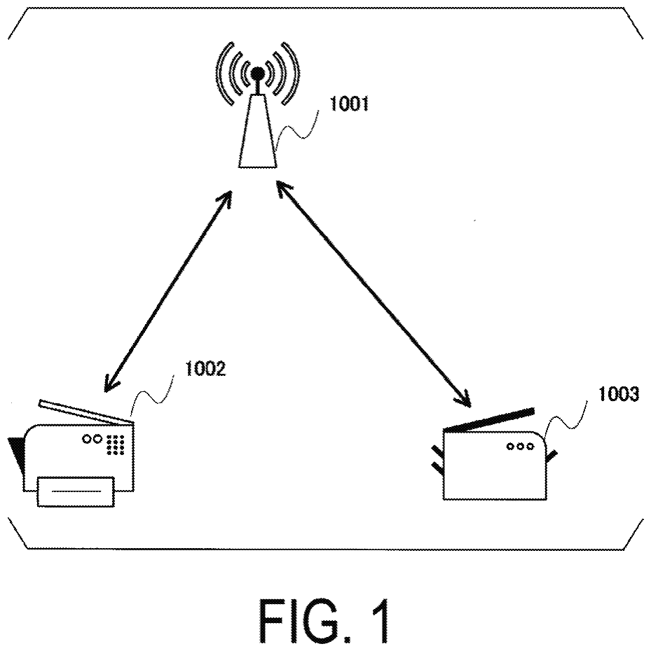

An embodiment of the present invention will be described in detail below with reference to the drawings. FIG. 1 illustrates an example of an apparatus configuration according to the present embodiment. A reference numeral 1001 denotes an access point (AP) including a function of wireless LAN such as the IEEE802.11 specification or the like as a communication method and a Wake up radio (WU radio (WUR)) function to wake up a connected station (STA) from a sleep state. Reference numerals 1002 and 1003 denote STAs that perform radio communication using a wireless LAN function (Primary radio (PR)) and a Main radio (MR) and can wake up from a standby state by the WU radio function from the access point 1001. The stations 1002 and 1003 can shift, in a connected state in which communication with the access point 1001 can be performed, in a case of determining that the apparatuses are not used, in a case of determining that the radio communication is not used for a while, to a sleep state in which communication with the access point 1001 through the wireless LAN is suspended. By transmitting a WU radio packet to any one or both of the stations 1002 and 1003, the access point 1001 can release and return the station 1002 or/and 1003 from the sleep state to a connected state in which communication can be performed.

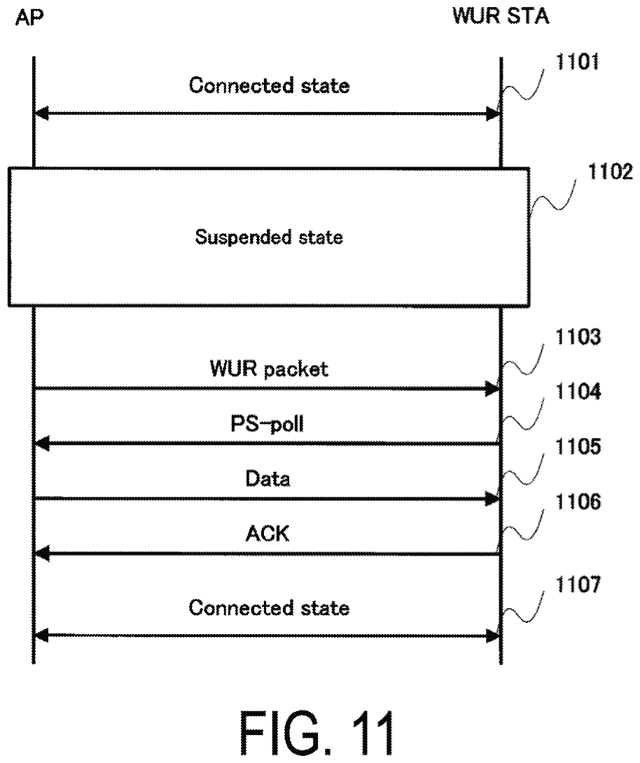

Referring to FIG. 11, an example of a process flow in which the station 1002 shifts a communication state with the access point 1001 from a connected state to a dormant state and returns to the connected state by the WU radio packet from the dormant state will be described. First, in 1101, it is assumed that a connected mode is established in which communication through the wireless LAN is performed between the access point 1001 and the station 1002. Next, in 1102, the station 1002 shifts to the dormant state, stops the wireless LAN function, and shifts to a standby mode in which only a WU radio signal (wake-up radio signal, WU radio frame, WU data frame, WU frame) is received. A procedure for shifting to this standby mode is not particularly specified, but as an example, a method of automatically shifting to the standby mode in a case that time during which there is no communication at the station 1002 exceeds a prescribed time, a method of notifying the access point 1001 from the station 1002 of shifting to the standby mode, a method of requesting the station 1002 from the access point 1001 to shift to the standby mode, or the like can be used. After the station 1002 shifts to the standby mode, in a case that transmission data for the station 1002 occur at the access point 1001, the access point 1001 transmits a WU radio packet to the station 1002 in step 1103. The station 1002 having received this WU radio packet makes the wireless LAN function a usable state, then transmits a PS-poll packet to the access point 1001 in step 1104, and performs notification that data from the access point 1001 can be received. The packet transmitted at this time may not be the ps-Poll, and a packet such as an NDP packet or the like without data may be used. The access point 1001 having received this ps-Poll packet determines that the station 1002 has recovered to the connected mode and communicates with the station 1002 in step 1107.

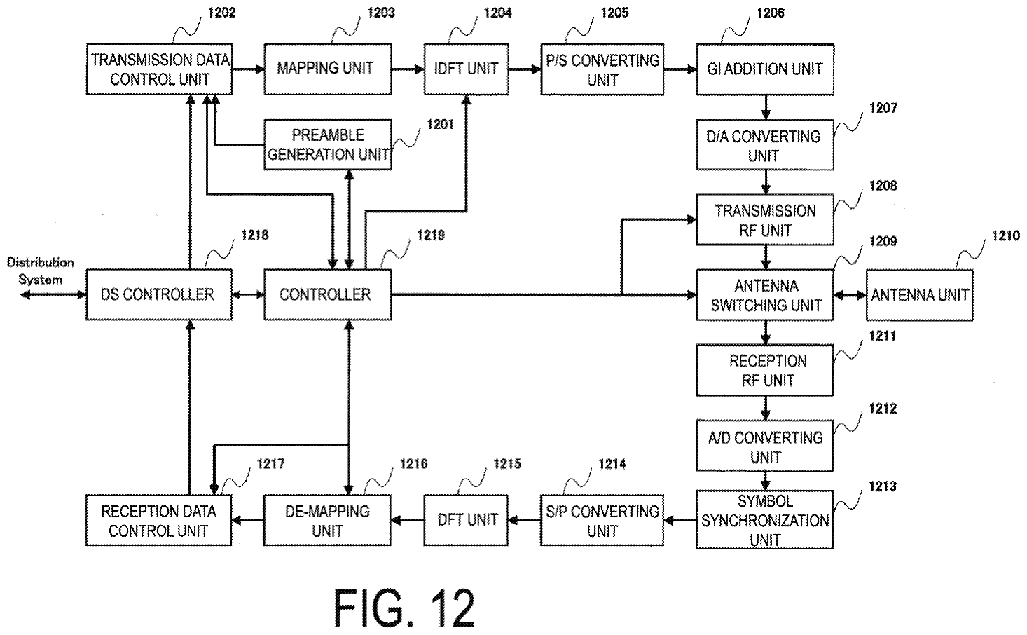

Referring to FIG. 12, an example of a configuration overview of the access point 1001 will be described. A reference numeral 1201 denotes a preamble generation unit that generates data of a preamble of a transmission packet according to an indication from a controller 1219. A reference numeral 1202 denotes a transmission data control unit that generates data to be allocated to each subcarrier of the transmission packet according to an indication from the controller 1219 based on the output from the preamble unit 1201 and communication data input from a DS controller 1218. A reference numeral 1203 denotes a mapping unit that configures the output from the transmission data control unit 1202 for each subcarrier of a data symbol of the transmission packet. A reference numeral 1204 denotes an IDFT unit that performs inverse discrete Fourier transform (IDFT) processing on the data configured for each subcarrier in the mapping unit 1203. A reference numeral 1205 denotes a parallel-serial (P/S) converting unit that rearranges the output of the IDFT unit 1204 in a transmission order. A reference numeral 1206 denotes a GI addition unit that adds a guard interval (GI) to the data input from the P/S converting unit 1205. A reference numeral 1207 denotes a D/A converting unit that performs digital-analog (D/A) conversion on the baseband data to which the guard interval is added in the GI addition unit 1206. A reference numeral 1208 denotes a transmission RF unit that converts the analog baseband signal input from the D/A converting unit 1207 to a signal having a frequency for transmission through an antenna unit 1210 and performs amplification to desired power. A reference numeral 1209 denotes an antenna switching unit that switches a connection destination of the antenna unit 1210 to either the transmission RF unit 1208 or a reception RF unit 1211. A reference numeral 1210 denotes the antenna unit through which transmission and reception of a signal with a prescribed frequency are performed. A reference numeral 1211 denotes the reception RF unit to which the signal received through the antenna unit 1210 is input via the antenna switching unit 1209 and that converts the signal to a baseband signal. A reference numeral 1212 denotes an A/D converting unit that performs analog-to-digital (A/D) conversion on the analog baseband signal input from the reception RF unit. A reference numeral 1213 denotes a symbol synchronization unit that detects a preamble from the A/D converted baseband signal, removes the guard interval in association with a symbol timing, and outputs a received signal from which the guard interval has been removed to an S/P converting unit 1214. A reference numeral 1214 denotes the P/S converting unit that parallelizes the input signal by serial-parallel (P/S) conversion and performs conversion into a discrete Fourier transform (DFT) processable format. A reference numeral 1215 denotes a DFT unit that performs DFT processing on the input signal. A reference numeral 1216 denotes a de-mapping unit that uses the signal after the DFT processing and estimates demodulation data from a signal point of each subcarrier. A reference numeral 1217 denotes a reception data control unit that extracts a packet structure from the data after the de-mapping, checks whether or not the received packet contains an error, and outputs, in a case that there is no error, the payload of the packet to a DS controller or the controller 1219. A reference numeral 1218 denotes the DS controller that exchanges reception data and transmission data with a distribution system (DS) for connecting to a network. A reference numeral 1219 denotes the controller that monitors the state of each block and controls each block in accordance with a predetermined procedure.

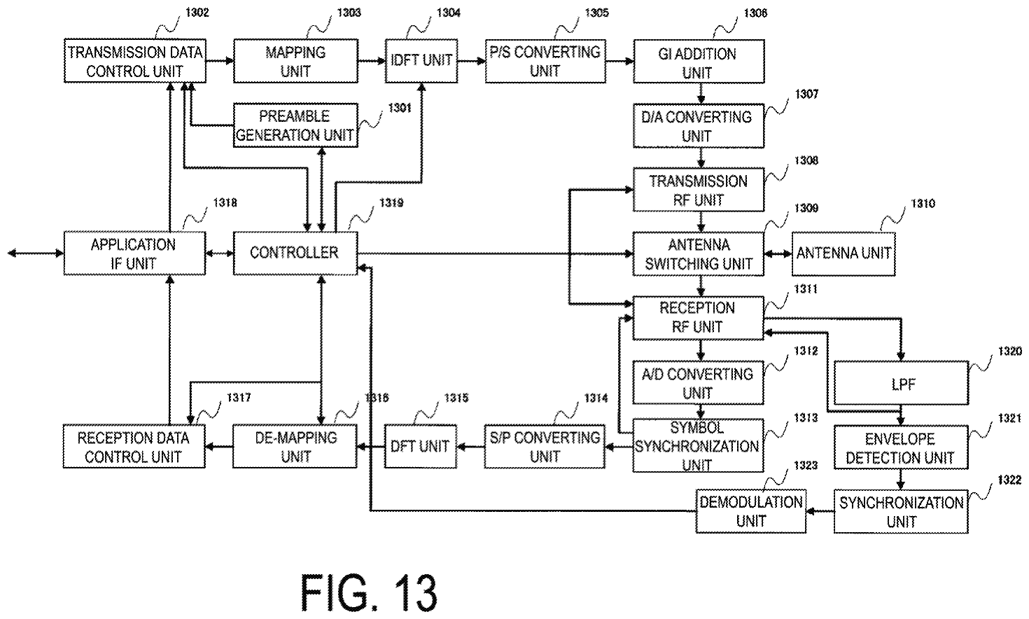

Referring to FIG. 13, an example of a configuration overview of each of the stations 1002 and 1003 will be described. The configuration overviews of the stations 1002 and 1003 are assumed to be the same. A reference numeral 1301 denotes a preamble generation unit that generates data of a preamble of a transmission packet according to an indication from a controller 1319. A reference numeral 1302 denotes a transmission data control unit that generates data to be allocated to each subcarrier of the transmission packet according to an indication from the controller 1319 based on the output from the preamble unit 1301 and communication data input via an application IF unit 1318. A reference numeral 1303 denotes a mapping unit that configures the output from the transmission data control unit 1302 for each subcarrier of a data symbol of the transmission packet. A reference numeral 1304 denotes an IDFT unit that performs inverse discrete Fourier transform (IDFT) processing on the data configured for each subcarrier in the mapping unit 1303. A reference numeral 1305 denotes a parallel-serial (P/S) converting unit that rearranges the output of the IDFT unit 1304 in a transmission order. A reference numeral 1306 denotes a GI addition unit that adds a guard interval (GI) to the data input from the P/S converting unit 1305. A reference numeral 1307 denotes a D/A converting unit that performs digital-analog (D/A) conversion on the baseband data to which the guard interval is added in the GI addition unit 1306. A reference numeral 1308 denotes a transmission RF unit that converts the analog baseband signal input from the D/A converting unit 1307 to a signal having a frequency for transmission through an antenna unit 1310 and performs amplification to desired power. A reference numeral 1309 denotes an antenna switching unit that switches a connection destination of the antenna unit 1310 to either the transmission RF unit 1308 or a reception RF unit 1311. A reference numeral 1310 denotes the antenna unit through which transmission and reception of a signal with a prescribed frequency are performed. A reference numeral 1311 denotes the reception RF unit to which the signal received through the antenna unit 1310 is input via the antenna switching unit 1309 and that converts the signal to a baseband signal. A reference numeral 1311 denotes an A/D converting unit that performs analog-to-digital (A/D) conversion on the analog baseband signal input from the reception RF unit. A reference numeral 1313 denotes a symbol synchronization unit that detects a preamble from the A/D converted baseband signal, removes the guard interval in association with a symbol timing, and outputs a received signal from which the guard interval has been removed to an S/P converting unit 1314. A reference numeral 1314 denotes the P/S converting unit that parallelizes the input signal by serial-parallel (P/S) conversion and performs conversion into a discrete Fourier transform (DFT) processable format. A reference numeral 1315 denotes a DFT unit that performs DFT processing on the input signal. A reference numeral 1316 denotes a de-mapping unit that uses the signal after the DFT processing and estimates demodulation data from a signal point of each subcarrier. A reference numeral 1317 denotes a reception data control unit that extracts a packet structure from the data after the de-mapping, checks whether or not the received packet contains an error, and outputs, in a case that there is no error, the payload of the packet to a DS controller or the controller 1319. A reference numeral 1318 denotes the DS controller that exchanges reception data and transmission data with a distribution system (DS) for connecting to a network. A reference numeral 1320 denotes a low-pass filter (LPF) unit for extracting a signal in a band of the WU radio signal from the received baseband signal. A reference numeral 1321 denotes an envelope detection unit that performs envelope detection on the output signal of the LPF unit 1320. A reference numeral 1322 denotes a synchronization unit that detects a preamble of the WU radio signal from the output signal of the envelope detection unit 1321. A reference numeral 1323 denotes a demodulation unit that demodulates the signal subsequent to the preamble of the WU radio packet. A reference numeral 1319 denotes the controller that monitors the state of each block and controls each block in accordance with a predetermined procedure.

In each of the connected state in which communication through the wireless LAN is performed and the standby mode state in which the function of receiving the WU radio signal is used, the stations 1002 and 1003 may control a power source state of each block constituting the stations 1002 and 1003, and optimize power consumption. As an example, in the connected state, the power consumed by the LPF unit 1320, the envelope detection unit 1321, the synchronization unit 1322, and the demodulation unit 1323 may be stopped, and in the standby mode state, it is sufficient that only the antenna switching unit 1309, the reception RF unit 1311, the LPF unit 1320, the envelope detection unit 1321, the synchronization unit 1322, the demodulation unit 1323, and the controller 1319 operate, and power consumed by other blocks may be stopped. In a case that the antenna switching unit 1309 is configured such that the antenna unit 1310 and the reception RF unit 1311 are connected in a case that the power source is not supplied, the power source to the antenna switching unit 1309 may be stopped. Additionally, the reception RF unit 1311 may be configured such that the reception RF unit 1311 consumes less power in a case of handling the WU radio signal than that in a case of handling the signal of the wireless LAN.

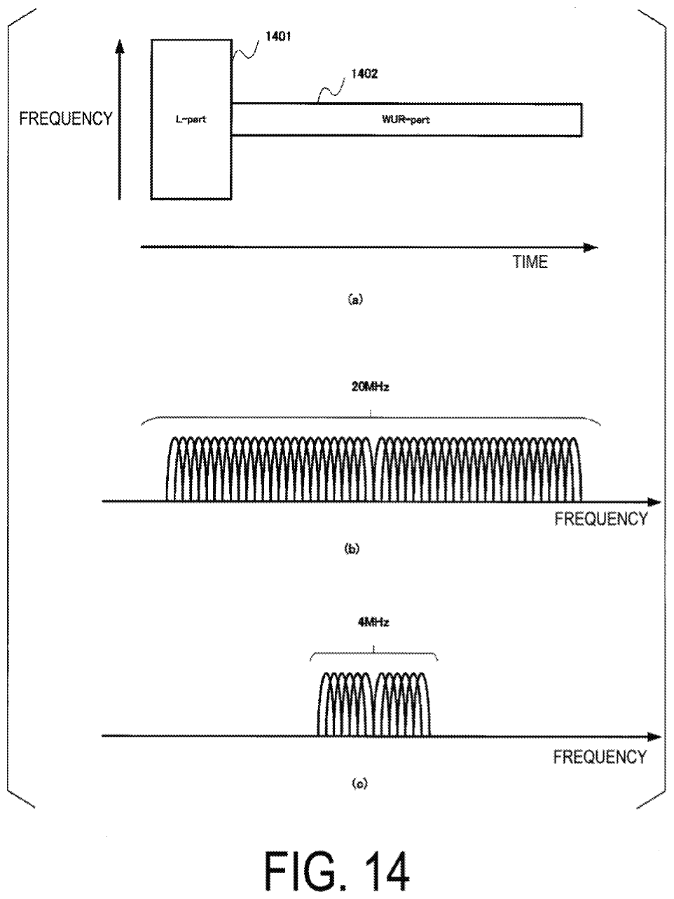

FIG. 14 illustrates examples of a configuration of the WU radio signal. In FIG. 14(a), a vertical axis indicates a frequency band occupied by the signal, and a horizontal axis indicates occupancy time in a time direction. A reference numeral 1401 denotes a legacy part (L-part) in which a signal that is compatible with the existing wireless LAN signal is used, and is a signal that can also be received by a station that cannot receive the WU radio signal. A reference numeral 1402 denotes a WU radio part (WUR-part), and is a signal for a station that can receive the WU radio signal. As illustrated in FIG. 14(a), the L-part 1401 is first transmitted and the WUR-part 1402 is subsequently transmitted. The WUR-part 1402 is narrower than the L-part 1401 in the band, and by using a signal form of a slow information speed, power used at demodulation can be reduced.

In the present embodiment, a signal of the L-part 1401 and a signal of the WUR-part 1402 are generated using the IDFT. FIG. 14(b) is a schematic diagram of a subcarrier allocation before the IDFT processing at the time of generating the L-part 1401. As an example, in a case that the number of processing points of the IDFT is 64 (an index range is taken as −32 to 31), subcarriers are allocated in a range where the index is −26 to 26, and a baseband signal after the IDFT is made to fall within a prescribed band, for example, 20 MHz. Note that an index 0 is not used as a DC (direct current) carrier. A value configured to the subcarrier at the IDFT is not particularly limited, but for example, a value used in a Short Training Field (STF), a Long Training Field (LTF), and a SIGnal (SIG) field defined by the IEEE802.11a standard may be used. Note that the number of points of the IDFT is not limited to 64, for example, the IDFT of 128 points may be used for a 40 MHz band, or the IDFT of 256 points may be used for an 80 MHz band. In a case of using the IDFT of 128 points or 256 points, the value of the subcarriers used in a case of using the IDFT of 64 points may be replicated and a value of the desired number of points may be prepared. FIG. 14(c) is a schematic diagram of a subcarrier allocation before the IDFT processing at the time of generating the WUR-part 1402. As an example, in a case that the number of processing points of the IDFT is 64, subcarriers are allocated in a range where the index is −6 to 6, and a baseband signal after the IDFT is made to fall within, for example, 4 MHz. Note that the index 0 is not used as the DC carrier. A value configured to the subcarrier at the time of the WUR signal transmission is not particularly specified, but as an example, at the time of preamble transmission of the L-part, for example, a method using a value of a subcarrier used in the STF or the LTF of the IEEE802.11a, a method using part of a pseudo-random number sequence such as an M sequence, or the like may be used.

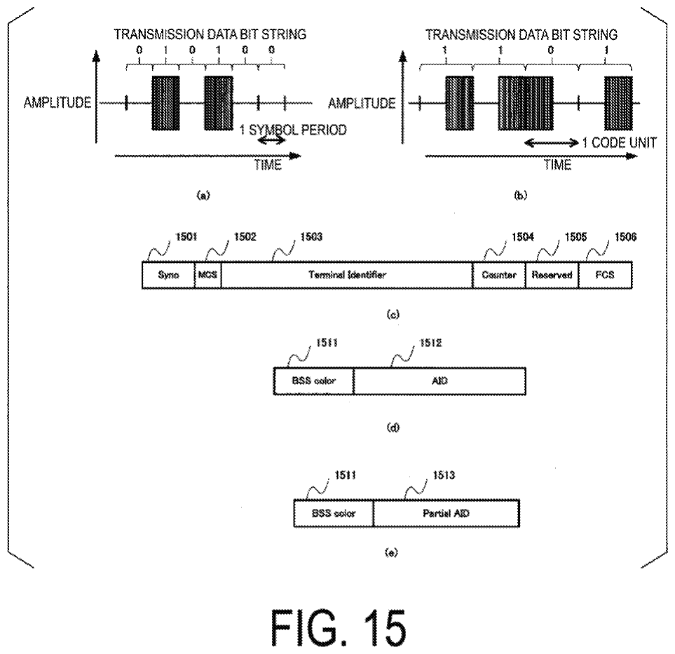

At the station on the reception side, in order to reduce power used at the time of demodulation of the WU radio signal, the WU radio signal is assumed to be in a form which can be subjected to the envelope detection. In the present embodiment, an on-off keying (OOK) modulation scheme is used. In the present embodiment, two coding types of coding with no code (no codes are used) and coding using a Manchester code are used as data coding, but one type of the coding method may be used, and more than two types may be used. An example of the WU radio signal at the time of performing the OOK modulation with no code is illustrated in FIG. 15(a). The modulation symbol uses a prescribed time as a unit, and the presence or absence of an amplitude of the WU radio signal is assigned to a transmission data bit. In the present embodiment, for the amplitude zero, the transmission bit is assumed to be zero, and for a state in which prescribed data are configured to the subcarrier used for transmission and the WU radio signal has the amplitude, the transmission bit is assumed to be one. An example of the WU signal at the time of performing the OOK modulation using the Manchester code is illustrated in FIG. 15(b). Two modulation symbols of the OOK modulation with no code are taken as one code unit, and assumed to be a modulation symbol after coding by the Manchester code. In the present embodiment, a state in which the OOK modulation symbol with no code is allocated in order of 0 and 1 is assumed as the transmission data bit 1 before the coding, and a state in which the OOK modulation symbol with no code is allocated in order of 1 and 0 is assumed as the transmission data bit 0 before the coding.

An overview of the WU radio frame structure used for the WUR-part 1402 in FIG. 14(a) is illustrated in FIG. 15(c). A reference numeral 1501 denotes a synchronization part for use in synchronization, and includes the prescribed number and values of OOK modulation symbols. For example, this synchronization part may include four OOK modulation symbols and the transmission data bits may have an allocation order of 1, 0, 1, and 0. A reference numeral 1502 denotes a field indicating a modulation scheme and coding scheme (Moduration and Coding Scheme (MCS)) of a subsequent modulation symbol, and indicates a case that the OOK modulation with no code is used using OOK modulation symbols with an allocation order of 1 and 0, and indicates a case that the OOK modulation using the Manchester code is used using OOK modulation symbols with an allocation order of 0 and 1. This is equivalent to transmitting information of 0 or 1 for identifying the MCS using the Manchester code. As a result, a terminal identifier field 1503, a counter field 1504, a reservation field 1505, and an FCS field 1506 are transmitted in the modulation scheme indicated by this MCS field 1502.

The MCS field may be omitted and notification of the MCS used by the terminal identifier field 1503, the counter field 1504, the reservation field 1505, and the FCS field 1506 may be performed by another method. As an example, multiple allocation orders of transmission data bits to be used in the synchronization part may be provided, and the notification of the MCS may be performed by using any of the multiple allocation orders, for example, in a case that an allocation order of 1, 0, 1, and 0 is used in the synchronization part, the OOK modulation using the Manchester code may be used, and in a case that an allocation order of 1, 0, 0, and 1 is used, the OOK modulation with no code may be used.

A reference numeral 1503 denotes the terminal identifier field, which includes information used to identify both or one of the access point transmitting the WU radio signal and the station receiving the WU radio signal. The information included in the terminal identifier field may not completely identify the access point or the station, and a length of the terminal identifier field may be shortened using information that may be assigned to multiple access points or multiple stations. As an example of a method for this shortening, as illustrated in FIG. 15(d), a constitution including a BSS color 1511 and an association identifier field 1512 (Association IDentifier (AID)) may be used, or as illustrated in FIG. 15(e), a constitution including the BSS color 1511 and a shortened AID (Partial AID) 1513 may be used. The BSS color is information that is expected to be employed in the IEEE802.11ax specification for which standardization work is currently being progressed, in which information of a shorter information length than the MAC address (48 bits), for example, a 6-bit length, is defined in order to approximately distinguish the access points, and is adjusted between the access points so as to be configured to different values as possible between access points that are present in neighborhood. The AID 1512 is an identifier, in a case that the station connects to the access point (performs Association process), assigned to the station from the access point, is information of 12-bit length in IEEE802.11 specification, and 1 to 1023 are assigned thereto. The Partial AID 1513 is defined by the IEEE802.11ac specification and is information of 9-bit length obtained by shortening the AID by a prescribed method. The AID 1512 and the Partial AID 1513 are information shorter than the MAC addresses (48 bits), and in a case that multiple access points are operated in the vicinity, there is a possibility that they overlap between stations connected to respective access points. Also, there is a possibility that the Partial AID 1513 overlaps between multiple stations that are connected to one access point. Processing in a case that the information of this terminal identifier field 1503 overlaps among multiple stations will be described later.

A reference numeral 1504 denotes a counter field, and is used in retry processing and reconnection processing. As an example, a 4-bit length counter may be used, and all bits thereof may be configured to 0 at the time of initial transmission of the WU radio signal. A reference numeral 1505 denotes the reservation field and is used at the time of function addition. A field length is not particularly specified, but as an example, the reservation field 1505 of 4-bit may be provided. The reservation field 1505 may be omitted in a case that the function addition is not performed in the future. A reference numeral 1506 denotes a Frame Check Sequence (FCS) field, includes a value for verifying whether or not reception data included from the terminal identifier field 1503 to the reservation field 1505 are correct, and as an example, Cyclic Redundancy Check (CRC) code, for example, CRC-8 in which a length of the generating polynomial is 9 bits, may be used.

Each of the stations 1002 and 1003 in the standby mode state for receiving the WU radio signal determines, by detecting that the output power of the LPF unit 1320 changes from a state of being lower than a prescribed threshold to a state of being higher than the prescribed threshold, that the L-part 1401 is received, and starts, after checking that the synchronization unit 1322 changes the output of the envelope detection unit 1321 as the allocation order of the data bits used in the synchronization part 1501, for example, 1, 0, 1, and 0, demodulation of the WU radio signal frame. The station that has detected the synchronization part 1501 receives the subsequent MCS field 1502, and estimates the MCS of the fields after the MCS field 1502. Each of these stations 1002 and 1003 utilizes this estimated result to demodulate the subsequent fields. Each of these stations 1002 and 1003 demodulates all of the terminal identifier field 1503, the counter field 1504, the reservation field 1505, and the FCS field 1506, utilizes the value in the FCS field 1506 to determine whether or not the terminal identifier field 1503, the counter field 1504, and the reservation field 1505 have been able to be correctly demodulated, and in a case that it can be determined that they have been able to be correctly demodulated, determines whether or not the terminal identifier field 1503 specifies the station itself. In a case that the terminal identifier field 1503 includes a value specifying the station itself, a power source is supplied to a block for communication using the wireless LAN signal of each of these stations 1002 and 1003 and a state in which communication using the wireless LAN signal can be performed is recovered. After the state in which communication using the wireless LAN signal can be performed is obtained, each of these stations 1002 and 1003 transmits a packet, for example, the ps-Poll packet, that is notification of wake-up to the access point 1001 and prompts the access point 1001 to transmit data to the station itself. Note that after receiving the MCS field 1502, at the time of receiving the terminal identifier field 1503, the value of the terminal identifier field 1503 may be checked without waiting for reception of the FCS field 1506, in a case that the value is not a value corresponding to the station itself, subsequent demodulation processing may be stopped, and the power consumption of the demodulation unit 1323 may be reduced until the next WU radio signal is detected. At this time, instead of checking all of the values in the terminal identifier field 1503, a value of a portion initially transmitted in the terminal identifier field 1503, for example, the BSS color 1511, may be checked, and the subsequent demodulation may be stopped in a case that the value is not a value corresponding to the station itself.

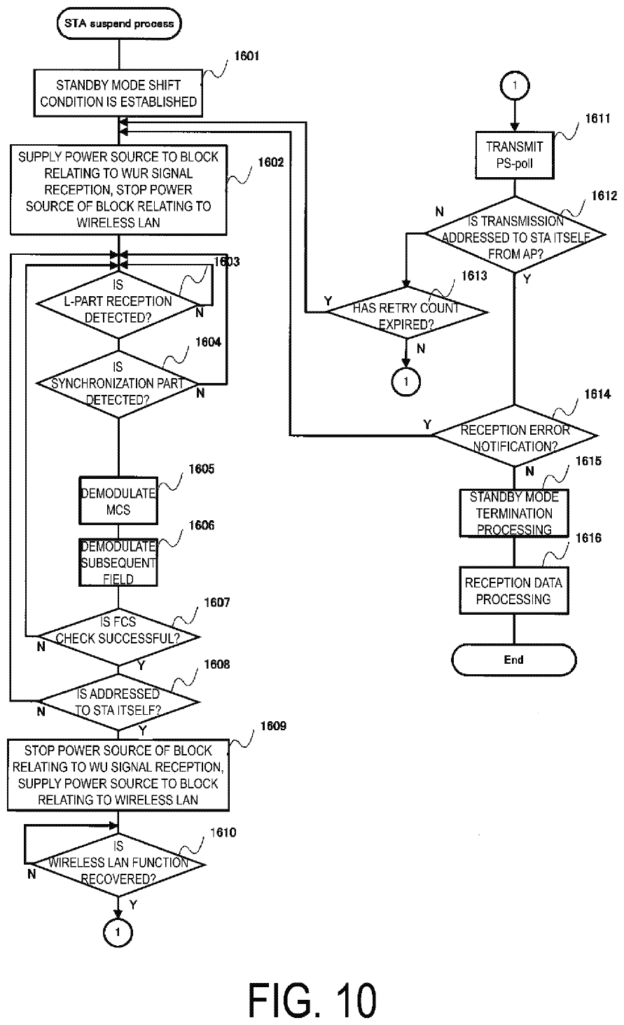

An overview of a series of processes in the standby mode of each of the stations 1002 and 1003 will be described using the flowchart of FIG. 10. First, in step 1601, in a case that a shift condition to the standby mode is established, each of the stations 1002 and 1003 supplies the power source to the multiple blocks for receiving the WU radio signal and stops the power source of the multiple blocks for receiving the wireless LAN signal. In this state, in step 1603, it is determined whether or not the signal of the L-part 1401 has been detected, and, in a case that the signal was not detected, step 1603 is repeated. In a case of detecting the signal of the L-part 1401, at step 1604, whether or not the synchronization part 1501 is included in the subsequent signal is detected, and the process returns to step 1603 in a case that the detection fails, and the process proceeds to step 1605 in a case that the detection is successful. In step 1605, the MCS field 1502, which follows the synchronization part 1501, is demodulated, and furthermore, it is determined how to demodulate the subsequent field. Then, in step 1606, all fields after the MCS field 1502 are demodulated. In next step 1607, the MCS field 1502 and subsequent fields are verified using the value in the FCS field 1506, the process proceeds to step 1608 in a case that this verification is successful, and the process proceeds to step 1603 in a case of failure. In step 1608, it is determined whether or not the value of the terminal identifier field 1503 indicates the station itself, the process returns to step 1603 in a case that the value of the terminal identifier field 1503 does not indicate the station itself, and the process proceeds to step 1609 in a case that the value of the terminal identifier field indicates the station itself. In step 1609, the power source supply to the block for receiving the WU radio signal is stopped and the block for using the wireless LAN signal is supplied with the power source. Next, recovery of the function of the block, which is supplied with the power source in step 1610, for using the wireless LAN signal is waited, and in a case that the recovery is confirmed, the process proceeds to step 1611. In step 1611, each of the stations 1002 and 1003 transmits the PS-poll packet to the access point 1001. Subsequently, in step 1612, it is determined whether or not transmission is made to each of the stations 1002 and 1003 itself from the access point 1001 for the PS-poll, the process proceeds to step 1613 in a case that it is determined that there is no transmission to each of the stations 1002 and 1003 itself, and the process proceeds to step 1614 in a case that it is determined that there is transmission to the station itself. In step 1613, it is determined whether or not the number of retransmission times of the PS-poll packet has expired, in a case of expiration, by assuming that the communication with the access point 1001 through the wireless LAN signal cannot be performed for some reason, in order for configuration to the standby state again, the process proceeds to step 1602, and in a case that the number of retransmission times has not expired, the process proceeds to step 1611 and the PS-poll packet transmission is performed again. In step 1614, it is determined whether or not the signal received from the access point 1001 is a reception error notification of the WU radio signal, and in a case of the reception error notification, the process proceeds to step 1602 and the state is returned to the standby state again, and in a case that the signal is not the reception error notification, the process proceeds to step 1615. This situation of receiving the reception error notification from the access point 1001 means that the same value of the terminal identifier field 1503 as each of the stations 1002 and 1003 itself is used by another station in the vicinity that utilizes the WU radio signal. In order to solve the state as described above, before returning to step 1602, each of the stations 1002 and 1003 may receive reassignment of the value used as the terminal identifier field 1503 by exchanging information with the access point 1001. At this time, reassignment of the AID 1512 and the Partial AID 1513 may be received. In step 1615, the standby mode terminates and each block is configured so that a signal can be received from the stations 1002 and 1003 using the wireless LAN signal, and each block is configured so that information other than information related to the standby state can be transmitted from the stations 1002 and 1003. Subsequently, in step 1616, the signal received in step 1614 is processed to be handled as normal reception data, and the standby mode terminates.

In order to perform each operation related to the standby mode described in the previous description, the access point 1001 may include information relating to the operation of the standby mode in information included in a beacon that is periodically transmitted and information transmitted from the access point 1001 to the stations 1002 and 1003 during an association process used by the stations 1002 and 1003 to connect to the access point 1001. Also, in information transmitted by the stations 1002 and 1003 to the access point 1001 during the association process, the information regarding the operation of the standby mode may be included. For example, the information transmitted from the stations 1002 and 1003 may include supporting/non-supporting information of the standby mode, MCS information of the WU radio signal receivable in the standby mode, information relating to an interval of receiving the WU radio signal, information for configuring which bands is used for the WU radio signal with respect to the band of the wireless LAN signal, and the like. Furthermore, information relating to the value used as the terminal identifier, information relating to the time and interval for transmitting the WU radio signal, and information relating to the power and band used at the time of transmitting the WU radio signal may be included in the information transmitted from the access point 1001 to the stations 1002 and 1003. An example of this information relating to the power and band will be described below.

In a case that the L-part 1401 and the WUR-part 1402 illustrated in FIG. 14(a) are used at the time of transmitting the WU radio signal, due to a legal regulation or the like, the total power and power density per band of each of the L-part 1401 and the WUR-part 1402 are changed in some cases. In such a case, problems may arise in automatic gain control (AGC) of the reception RF unit 1311 at the time of receiving the WU radio signal. For example, in a case that the L-part 1401 is assumed to be 20 MHz in band and 200 mW in total power and the WUR-part 1402 is assumed to be 4 MHz in band and 200 mW in total power, the power density of the L-part 1401 per 1 MHz is 10 mW/MHz, and the power density of the WUR-part 1402 per 1 MHz is 50 mW/MHz. Additionally, in a case that the L-part 1401 is assumed to be 20 MHz in band and 200 mW in total power and the WUR-part 1402 is assumed to be 4 MHz in band and 40 mW in total power, the power density of the L-part 1401 per 1 MHz is 10 mW/MHz, and the power density of the WUR-part 1402 per 1 MHz is 10 mW/MHz. In the former case, in a case that a band of a feedback signal utilized by the AGC at the time of receiving the WU radio signal is assumed to be 4 MHz of the WUR-part 1402, the power of the feedback signal varies greatly between the L-part 1401 and the WUR-part 1402, and in the latter case, in a case that the band of the feedback signal is assumed to be 20 MHz of the L-part 1401, the signal power of the WUR-part 1402 output to the subsequent stage is reduced. In other words, it is necessary to change the operation configuration of the reception RF unit 1311 depending on the band and power of each of the L-part 1401 and the WUR-part 1402. In order to change this configuration of the reception RF unit 1311, the LPF unit 1320, the envelope detection unit 1321, or the like, the stations 1002 and 1003 may be notified of information regarding the power and band used at the time of the access point 1001 transmitting the WU radio signal. This information may include one or more kinds of information relating to the signal band, total power, and power density of the L-part 1401. Additionally, one or more kinds of information relating to the signal band, total power, and power density of the WUR-part 1402 may be included. Additionally, for the total power or power density, information relating to a ratio between the L-part 1401 and the WUR-part 1402 may be included.

Prior to the stations 1002 and 1003 receiving information relating to the signal band, total power, and power density of the WUR-part 1402 from the access point 1001, information relating to at least any one of the signal band, total power, and power density of the WUR-part 1402 that can be received by the stations 1002 and 1003 may be transmitted from the stations 1002 and 1003 to the access point. The access point 1001 may determine, in consideration of this information regarding at least any one of the signal band, total power, and power density of the WUR-part 1402 transmitted from the stations 1002 and 1003, the signal band, total power, power density, and the like of the WUR-part 1402, and notify the stations 1002 and 1003 of information including one or more kinds of information relating to the signal band, total power, and power density.

The access point 1001 may configure such that the bands of the L-part 1401 and the WUR-part 1402 of the WU radio signal to be transmitted to the stations 1002 and 1003 can be changed. For example, the signal bandwidth of the L-part 1401 may be configured such that any one of 20 MHz, 40 MHz, and 80 MHz can be selected. Additionally, the signal bandwidth of the WUR-part 1402 may be configured such that any one of 2 MHz, 4 MHz, 8 MHz, and 16 MHz can be selected.

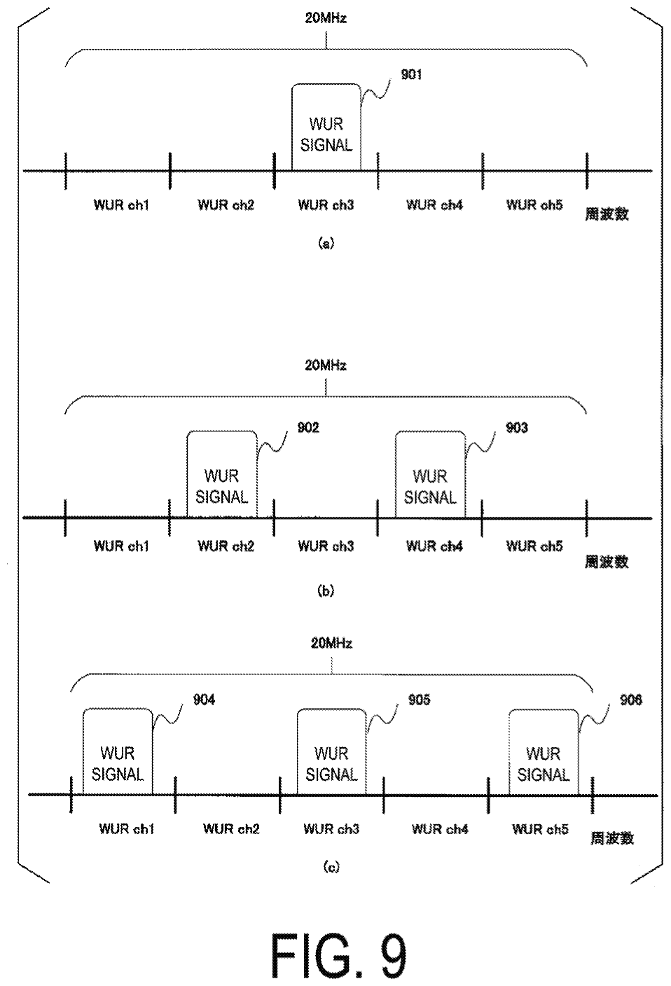

Although the description has already been given that the same value can be assigned to the terminal identifier field 1503 for the multiple stations, in order to reduce the possibility that the multiple stations to which the same value of the terminal identifier field 1503 is assigned simultaneously receive the WU radio signal to which the assigned value of the terminal identifier fields 1503 is configured, the assignment of bands in which the WU radio signal is transmitted may be changed in the bands of the wireless LAN signal. This will be described with reference to FIG. 9. As an example, an example is described in which a band of the wireless LAN signal is taken as 20 MHz, a band of the WU radio signal is taken as 4 MHz, and the WU radio signal is transmitted in each band obtained by dividing the band of the wireless LAN signal into five equal bands. These bands obtained by dividing into five equal bands are taken as WU radio channels, and are taken as a WU radio channel 1, a WU radio channel 2, a WU radio channel 3, a WU radio channel 4, and a WU radio channel 5 in order from a lower side in the band of wireless LAN signal. Allocating the WU radio channels in this manner allows the center frequency of the WU radio channel 3 to be equal to the center frequency of the wireless LAN signal, and makes it possible to assign the WU radio channel 3 to a station in which the multiple WU radio signal channels cannot be configured within the frequency band of the wireless LAN signal. FIG. 9(a) illustrates a schematic view of a case in which a WU radio signal 901 is assigned to the WU radio channel 3. This state is equivalent to the WU radio signal illustrated in FIG. 14 and the WU radio signal 901 can be received by a station using the configuration of FIG. 13 described above.

Next, as an example, FIG. 9(b) illustrates a schematic view of a case in which the WU radio channel 2 is used in a case that a WU radio signal 902 is transmitted to the station 1002 and the WU radio channel 4 is used in a case that a WU radio signal 903 is transmitted to the station 1003. The station may transmit the WU radio signal 902 and the WU radio signal 903 one by one or may transmit at the same time. Each of the stations 1002 and 1003 changes the configuration of the reception RF unit 1311 at the time of shifting to the standby mode and changes beforehand a frequency to be received to the WU radio channel that is assigned, and changes the configuration of the reception RF unit 1311 at the time of returning from the standby mode and receives the original frequency. Largely depending on properties of the reception RF unit 1311 and the LPF unit 1320 used in a case that the stations 1002 and 1003 receive the WU radio signal, in a case of simultaneously transmitting the WU radio signal 902 and the WU radio signal 903 and in a case that the stations 1002 and 1003 do the WU radio signals of the WU radio channels that are assigned thereto, respectively, there is a possibility of reception of disturbance from a signal of an adjacent WU radio channel. To avoid this disturbance from the adjacent WU radio channel, the interval of the WU radio channels that is assigned by the access point 1001 may be spoken. FIG. 9(b) illustrates a case that an unused WU radio channel (WUR ch3) is provided between the two WU radio channels (WUR ch2 and WUR ch4) that are assigned. To help determination of this interval, information relating to performance of rejecting the adjacent WU radio channel may be transmitted from the stations 1002 and 1003 to the access point 1001. The number of WU radio signals that the access point 1001 transmits at a time is not limited to two, and a number greater than two may be used. FIG. 9(c) illustrates an example of a WU radio channel assignment in which three WU radio signals can be simultaneously transmitted. In addition, in FIG. 9, a channel allocation in which the WU radio channels do not overlap is illustrated, but the WU radio channels may be allowed to overlap, and the frequency at which the WU radio signal is allocated may be increased.

In a case of transmitting multiple WU radio signals, due to limitation on transmit power of the access point 1001 and a legal regulation, it is necessary in some cases to reduce the power of the WU radio signal per one signal as compared to a case of transmitting only one WU radio signal. In such a case, the transmit power at the time of transmitting the multiple WU radio signals may be applied to the case of transmitting only one WU radio signal. In a case that the access point 1001 transmits information relating to at least any one of the signal band, the total power, and the power density of the WU radio signal to the stations 1002 and 1003, a value based on the transmission power at the time of transmitting the multiple WU radio signals may be used.

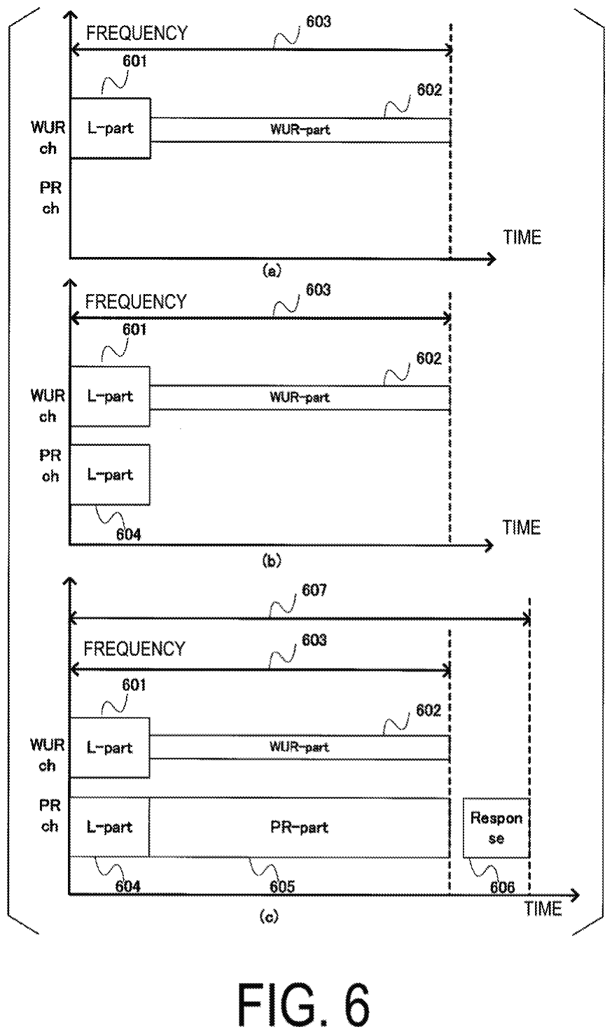

The AP 1001 according to the present embodiment can transmit the frame using both radio functions of the WU radio and the primary radio. FIG. 6 is a schematic diagram illustrating an example of the frame transmission according to the present embodiment. As illustrated in FIG. 6(a), the access point 1001 can transmit a WU radio signal on a radio channel (WUR ch) on which a WU radio signal is transmitted. Furthermore, the access point 1001 can transmit or receive a primary radio signal on a radio channel (PR ch) on which a primary primary radio signal is transmitted or received. Note that the radio channels configured to the WUR ch and the PR ch are preferably adjacent radio channels. Here, a position of the radio channel configured by the access point 1001 can conform to the channelization that is specified in the IEEE802.11 standard. Accordingly, the access point 1001 need not necessarily allocate the WUR ch and the PR ch to adjacent radio channels. For example, in a case that, on the PR ch, the access point 1001 operates the primary radio at an operation bandwidth of 80 MHz, among four 20 MHz sub-channels included in the bandwidth of 80 MHz (referred to as a ch1, a ch2, a ch3, and a ch4, from the lowest frequency), the access point 1001 can transmit the primary radio signal on the ch1 and the WU radio signal on the ch4 respectively.

In FIG. 6(a), the access point 1001 transmits the WU radio signal, but does not transmit the primary radio signal. At this time, the station in a reception state in the WUR ch can receive any one or both of an L-part 601 and a WUR-part 602 included in the WU radio signal. For example, in a case that the station 1002 can receive the L-part 601, since the station 1002 maintains the reception state for the WU radio signal during a time period 603, the station 1002 does not perform frame transmission during the time period 603.

Incidentally, the access point 1001 can transmit or receive the primary radio signal on the PR ch. However, in a case of being in a transmission operation of the WU radio signal on the WUR ch, the access point 1001 cannot start a reception operation on the PR ch. At this time, in a case that the station 1003 connected to the access point 1001 cannot receive the WU radio signal, since it cannot be recognized that the access point 1001 is in the transmission operation of the WU radio signal, there is a possibility that the station 1003 transmits the primary radio signal on the PR ch. Of course, the access point 1001 during the transmission operation of the WU radio signal cannot receive the primary radio signal. As a result, the primary radio signal is not correctly received by the access point 1001. Thus, for example, in a case that the primary radio signal transmitted by the station 1003 is a frame that causes a response signal, the station 1003 that cannot receive the response signal will retransmit the primary radio signal. This reduces channel access efficiency of access points and stations belonging to surrounding BSSs in which the PR ch is reused.

Although the problems described above are caused by the fact that the station 1003 cannot correctly receive the WU radio signal, the above problems may arise even in a case that the station 1003 includes a function by which the WU radio signal can be received. This is because, the station 1003 can start the reception operation for the WU radio signal in a case of being in the standby state, but the station 1003 that has received the WU radio signal subsequently performs communication by the primary radio, and does not start the reception operation of the WU radio signal.

Thus, the access point 1001 according to the present embodiment can simultaneously transmit, as illustrated in FIG. 6(b), in a case of transmitting the WU radio signal on the WUR ch, the primary radio signal on the PR ch. Here, “simultaneously” also means that the access point 1001 transmits the WU radio signal and the primary radio signal in parallel using different radio channels. Additionally, “simultaneously” does not necessarily mean that the access point 1001 starts to transmit the WU radio signal and the primary radio signal exactly at the same time using different radio channels. In a case that a reception device that observes the WU radio signal and the primary radio signal can consider that the two radio signals have been simultaneously transmitted, it can be said that the access point 1001 has simultaneously transmitted the WU radio signal and the primary radio signal. For example, in a case that the WU radio signal and the primary radio signal are signals including a guard interval, as long as a difference in the reception timing of both signals falls within the guard interval, the WU radio signal and the primary radio signal can be considered to be simultaneously transmitted.

According to the example illustrated in FIG. 6(b), the access point 1001 can transmit an L-part 604 on the PR ch. Here, the access point 1001 can transmit, as the L-part 604, the same signal as the L-part 601 and a signal resulting from phase rotation of the L-part 601. In this phase rotation, the phase of each subcarrier used at the time of transmission may be changed, or a subcarrier subjected to the phase rotation and a subcarrier not subjected to the phase rotation may be used. The access point 1001 can transmit, as the L-part 604, a preamble (PHY header) defined by any of the IEEE802.11a/b/g/n/ac/ax standards. This means that preambles included in the radio signals respectively transmitted by the access point 1001 on the PR ch and the WUR ch may differ in length from each other. Here, the preamble is a signal including any one of or some of the SIG, STF, and LTF fields. In either case, the access point 1001 can write information indicating the time period 603 as information (Duration, Length, TXOP) for indicating a frame length to be written in the L-part 604. Note that although FIG. 6(b) illustrates a state in which the access point 1001 transmits only the L-part 604 on the PR ch, the access point 1001 can further transmit a radio signal on the PR ch subsequent to the L-part 604.

The access point 1001 transmits such a primary radio signal together with the WU radio signal, and the station 1003 that does not receive the WU radio signal does not start, by receiving the primary radio signal, the operation of transmitting the primary radio signal to the access point 1001, at least during the time period 603. Accordingly, the station 1003 does not transmit the primary radio signal on the PR ch to the access point 1001 that has not transitioned to the reception state on the PR ch. At this time, since access points and stations belonging to another BSS in a relationship of an OBSS can transmit the primary radio signal and the WU radio signal on the PR ch, the frequency efficiency of the PR ch can be improved. Also from this, the access point 1001 can include, in the L-part 604, information (e.g. BSS color) indicating that the access point 1001 or a device belonging to a BSS managed by the access point 1001 has performed transmission.

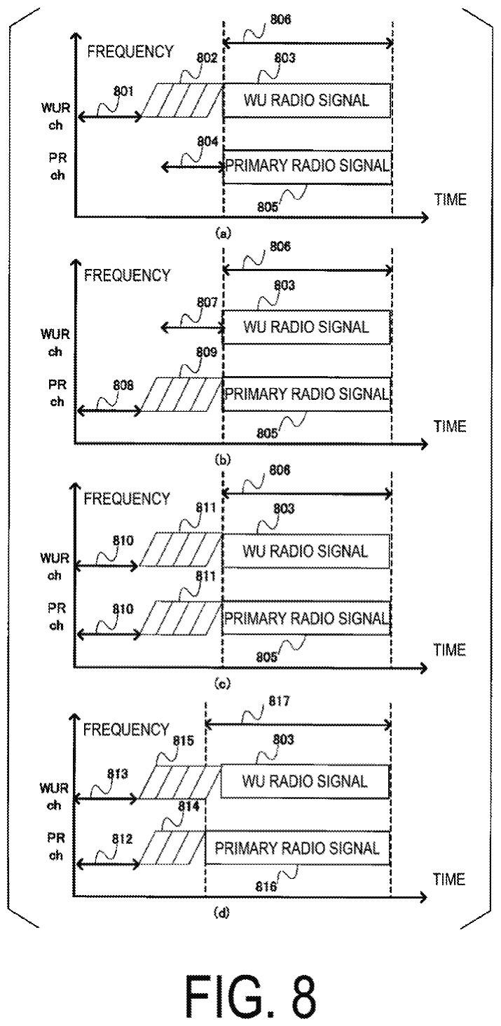

In a case of simultaneously transmitting the WU radio signal and the primary radio signal, the access point 1001 needs to perform a carrier sense on each frequency channel. FIG. 8 is a schematic diagram illustrating an example of a state of a carrier sense operation performed by the access point 1001 according to the present embodiment. As illustrated in FIG. 8(a), on the WUR ch, the access point 1001 performs a carrier sense including a prescribed period (first period) indicated by a period 801 (e.g., DIFS or AIFS) and a random back-off indicated by a period 802. Additionally, on the PR ch, as indicated by a period 804, the access pin and 1001 can perform a carrier sense from a point of time which is a prescribed period (second period) (e.g. PIFS (25 us)) earlier than a point of time when the random back-off ends on the WUR ch. In a case that both the WUR ch and the PR ch can be determined to be in an idle state, the access point 1001 can simultaneously transmit a WU radio signal 803 and a primary radio signal 805. In a case that only the WUR ch can be determined to be in the idle state, the access point 1001 can transmit only the WU radio signal. In a case that only the PR ch can be determined to be in the idle state, the access point 1001 must not transmit the primary radio signal.

Although, in the previously described method, the access point 1001 performs the carrier sense including the random back-off on the WUR ch, the access point 1001 may perform the carrier sense including the random back-off on the PR ch, as illustrated in FIG. 8(b). That is, on the PR ch, the access point 1001 can perform the carrier sense for a period 808 and a prescribed period including the random back-off indicated by a period 809, and on the WUR ch, as indicated by a period 807, can also perform the carrier sense from a point of time which is a prescribed period earlier than a point of time when the random back-off ends on the PR ch. At this time, in a case that only the PR ch can be determined to be in the idle state, the access point 1001 must not transmit the WU radio signal 803 on the WUR ch, but can transmit the primary radio signal 805 on the PR ch. In this case, it is not necessary to write information associated with the WU radio signal (e.g., the WU radio signal transmission period) in the primary radio signal.

Additionally, in a case that only the PR ch can be determined to be in the idle state, the access point 1001 can also transmit the WU radio signal on the PR ch. However, the access point 1001 needs to notify stations belonging to a BSS managed by the access point 1001 that there is a possibility that the WU radio signal is transmitted on the PR ch. Additionally, in a case of transmitting the WU radio signal on the PR ch, the access point 1001 can perform a protection operation in order to protect a station that cannot receive the WU radio signal on the PR ch. The protection operation may be performed by transmitting a CTS-to-self frame by the access point 1001. Additionally, the access point 1001 can allow only a station capable of receiving the WU radio signal on the PR ch to connect to the BSS.

The access point 1001 can perform the carrier sense including the random back-off operation on both the WUR ch and the PR ch. As illustrated in FIG. 8(c), the access point 1001 can perform the carrier sense using a period 811 indicated by a common random back-off value on the WUR ch and the PR ch. That is, prior to transmission of the WU radio signal, the access point 1001 selects one random back-off value (contention window value), performs the carrier sense for a prescribed period (e.g. AIFS or DIFS) indicated by a period 810 on both the WUR-ch and the PR ch, and then can further perform the carrier sense for a period (e.g., random back-off value×9 us), which is determined by a random back-off value indicated by the period 811. In a case that both the channels of the WUR ch and the PR ch are determined to be in an idle state by the carrier sense operation, the access point 1001 can simultaneously transmit the WU radio signal 803 and the primary radio signal 805.

Additionally, as illustrated in FIG. 8(d), the access point 1001 can perform the carrier sense including an independent random back-off operation on each of the WUR ch and the PR ch. In this case, the access point 1001 can independently select the random back-off value on each of the WUR ch and the PR ch. At this time, in a case that the random back-off value on the PR ch is different from the random back-off value on the WUR ch, each of which is selected by the access point 1001, or in a case that a length of a prescribed period during which the carrier sense is performed prior to the random back-off operation is different between the WUR ch and the PR ch, there is a possibility that the access point 1001 transmits a primary radio signal 816 prior to the transmission of the WU radio signal 803. On the other hand, there is also a possibility that the access point 1001 transmits the primary radio signal 816 after starting transmission of the WU radio signal 803. In either case, the access point 1001 performs transmission by including, in the primary radio signal 816, information indicating a period (period 817) from the transmission start of the primary radio signal 816 to the transmission end of the WU radio signal 803 to be assumed. Note that in a case that the WUR ch is determined to be in the busy state thereafter, the access point 1001 does not transmit the WU radio signal, but in this case, on the PR ch, the access point 1001 can transmit the primary radio signal (for example, CF-end frame) including information indicating that a transmission right acquired by the access point 1001 itself on the PR ch is to be discarded.

An internal parameter referenced by the access point 1001 in a case of determining the random back-off value may be either an internal parameter used by the access point 1001 in a case of transmitting the WU radio signal or an internal parameter used in a case of transmitting the primary radio signal. Although, it is natural that, in a case of transmitting the WU radio signal (or primary radio signal), the access point 1001 refers to the internal parameter of the WU radio (or primary radio), for example, the access point 1001 can determine the random back-off value used in transmitting the primary radio signal based on the CW configured for each AC of the WU radio.

Additionally, the access point 1001 can refer to some of the internal parameters as common values between the WU radio and the primary radio. The access point 1001 can cause values, such as the CW, a CW_min, a CW_max, a retry counter, an AIFSN, and the like configured for each AC, to be common between the WUR and the PR. For example, in a case that the access point 1001 transmits the primary radio signal in a prescribed AC and cannot correctly transmit the primary radio signal, the CW value is increased. In a case that the access point 1001 successively transmits the WU radio signal in the AC, the access point 1001 can configure the random back-off value using the CW value changed by the transmission operation of the primary radio signal.

The access point 1001 can transmit, prior to transmission of the WU radio signal, the primary radio signal (e.g. CTS-to-self) including information indicating that, to the PR ch, the access point 1001 itself has reserved the PR ch for a prescribed period, on the PR ch. Note that the access point 1001 can transmit the primary radio signal by including therein information (e.g. BSS color) indicating that the access point 1001 or an apparatus belonging to a BSS managed by the access point 1001 has performed transmission. The access point 1001 can transmit the primary radio signal by including therein information indicating a time period required for the access point 1001 to transmit the WU radio signal on the WUR ch. Note that in a case that the transmission period reserved by the primary radio signal is shorter than the time period required for the access point 1001 to actually transmit the WU radio signal, the access point 1001 can transmit, after completing the transmission of the WU radio signal, the primary radio signal (for example, CF-end frame) including information indicating that the transmission period reserved by the access point 1001 is to be discarded on the PR ch.

The access point 1001 can also include a PR-part 605 as illustrated in FIG. 6(c). That is, for example, the access point 1001 can transmit the WU radio signal to the station 1002 and the primary radio signal to the station 1003 at the same time. Note that in a case that the primary radio signal is a frame that causes a Response 606 (e.g., ACK frame), and in a case that the Response 606 occurs during the time period 603 during which the access point 1001 is transmitting the WU radio signal, the access point 1001 cannot receive the Response 606. Accordingly, in a case that the access point 1001 transmits the primary radio signal that causes the Response 606, the primary radio signal can be transmitted such that the Response 606 occurs after the access point 1001 completes the transmission of the WU radio signal and starts the reception operation on the PR ch. For example, as illustrated in FIG. 6(c), the access point 1001 can cause frame lengths of the WU radio signal and the primary radio signal to be equal to each other. In this case, the access point 1001 writes different values in the Length (Duration) fields of the L-part 601 and the L-part 604, respectively. However, the access point 1001 can configure a larger value in the Length field of the L-part 604 than a value of the Length field value of the L-part 601. Additionally, the value of the Length field configured for the L-part 601 may be the L-part 604 that is transmitted on the PR ch rather than the length 603 of the WUR-part 602. Additionally, in a case that the WU radio signal is not transmitted on the WUR ch, both the PR ch and the WUR ch may be used to transmit the PR-part. Additionally, the number of channels used as the primary radio is not limited to one, and multiple radio channels may be used simultaneously. At this time, the number of radio channels of the primary radio that transmits the L-part 604 at the time of transmission of the WU radio signal may be one, or the L-part 604 signal may be transmitted on multiple channels of the primary radio.

Furthermore, the access point 1001 can also transmit the WU radio signal to be transmitted on the WUR ch, on the PR ch. That is, the access point 1001 can replicate the WU radio signal and transmit each of the replicated signals on the WUR ch and the PR ch. At this time, the access point 1001 can apply a different phase rotation to each of the replicated WU radio signals, and transmit the replicated WU radio signals. In this case, the station 1002 can receive the WU radio signal by starting a reception operation for the WU radio on either the WUR ch or the PR ch. Additionally, the station 1002 combines the WU radio signals respectively received on the WUR ch and the PR ch, and receives the combined WU radio signal, thereby making it possible to improve the reception quality of the WU radio signal. In this case, the access point 1001 can broadcast, to stations in the BSS, that there is a possibility that signals obtained by replication of the WU radio signal are transmitted from multiple radio channels. Additionally, the station 1002 can notify the access point 1001 that a function by which the WU radio signals transmitted on the multiple radio channels can be received is included.

The access point 1001 can perform the carrier sense using a different carrier sense level (minimum reception sensitivity, CCA threshold) between the WUR ch and the PR ch.

In a case of transmitting the WU radio signal on the PR ch, the access point 1001 can perform the carrier sense using a carrier sense level less than or equal to the carrier sense level used for the carrier sense performed in a case of transmitting the primary radio signal on the PR ch.

In a case of simultaneously transmitting the WU radio signal and the primary radio signal, the access point 1001 can perform the carrier sense using a common carrier sense level. At this time, the access point 1001 can use a carrier sense level to be used for a radio signal transmitted on a radio channel on which the carrier sense including the random back-off operation is performed, for a radio signal transmitted on a radio channel on which the carrier sense that does not include the random back-off operation is performed.

Note that the station 1003 can include a function of receiving the WU radio signal at the same time, even in a state in which communication by the primary radio signal is performed. In this case, the station 1003 can notify the access point 1001 that a function by which the primary radio signal and the WU radio signal can be simultaneously received is included. The access point 1001 can transmit only the WU radio signal in a case that it can be recognized that all stations connected to the BSS managed by the access point 1001 include the function by which the primary radio signal and the WU radio signal can be simultaneously received.

Note that in a case of starting the reception operation for the WU radio on the WUR ch, the station 1002 can receive the WU radio signal transmitted by the access point 1001. At this time, in a case that the station 1002 has been able to recognize that the WU radio signal is a radio signal addressed to the station 1002, the station 1002 can start the reception operation for the primary radio on the PR ch. That is, the station 1002 can switch the radio channel starting the reception operation by receiving the WU radio signal. Note that the station 1002 can start the reception operation for the WU radio again on the WUR ch after performing communication in the primary radio. At this time, the station 1002 can stop the reception operation for the primary radio on the PR ch.

The access point 1001 can change the radio channel to be configured to the PR ch or the WUR ch. The access point 1001 can broadcast information, in the BSS, for indicating which radio channel is configured to the PR ch or the WUR ch. In a case of changing the radio channel to be configured to the PR ch or the WUR ch, the access point 1001 can broadcast information, in the BSS, for indicating that the radio channel is to be changed prior to changing the radio channel. The access point 1001 can broadcast the information indicating that the radio channel is to be changed by using any one or both of the radio channels of the PR ch and the WUR ch. The access point 1001 can include information indicating timing of changing the radio channel in the information indicating that the radio channel is to be changed. The access point 1001 can use, as the information indicating the timing of changing the radio channel, information associated with the number of transmission times of the radio signal to be transmitted at the time of broadcasting the information indicating that the radio channel is to be changed.

According to the method described above, since the access point in the BSS does not transmit the primary radio signal while the access point 1001 is transmitting the WU radio signal, interference to a BSS in a relationship of the OBSS is reduced, and thus improvement in frequency efficiency can be expected.

### Second Embodiment

FIG. 14 illustrates examples of a configuration of the WU radio signal according to the present embodiment. In FIG. 14(a), a vertical axis indicates a frequency band occupied by the signal, and a horizontal axis indicates occupancy time in a time direction. A reference numeral 1401 denotes a legacy part (L-part) in which a signal that is compatible with the existing wireless LAN signal is used, and is a signal that can also be received by a station that cannot receive the WU radio signal. A reference numeral 1402 denotes a WU radio part (WUR-part), and is a signal for a station that can receive the WU radio signal. As illustrated in FIG. 14(a), the L-part 1401 is first transmitted and the WUR-part 1402 is subsequently transmitted. The WUR-part 1402 is narrower than the L-part 1401 in the band, and by using a signal form of a slow information speed, power used at demodulation can be reduced.

In the present embodiment, a signal of the L-part 1401 and a signal of the WUR-part 1402 are generated using the IDFT. FIG. 14(b) is a schematic diagram of a subcarrier allocation before the IDFT processing at the time of generating the L-part 1401. As an example, in a case that the number of processing points of the IDFT is 64 (an index range is taken as −32 to 31), subcarriers are allocated in a range where the index is −26 to 26, and a baseband signal after the IDFT is made to fall within a prescribed band, for example, 20 MHz. Note that an index 0 is not used as a DC (direct current) carrier. A value configured to the subcarrier at the IDFT is not particularly limited, but for example, a value used in a Short Training Field (STF), a Long Training Field (LTF), and a SIGnal (SIG) field defined by the IEEE802.11a standard may be used. A signal for further compatibility may be added after the SIG field. Note that the number of points of the IDFT is not limited to 64, for example, the IDFT of 128 points may be used for a 40 MHz band, or the IDFT of 256 points may be used for an 80 MHz band. In a case of using the IDFT of 128 points or 256 points, the value of the subcarriers used in a case of using the IDFT of 64 points may be replicated and a value of the desired number of points may be prepared. FIG. 14(c) is a schematic diagram of a subcarrier allocation before the IDFT processing at the time of generating the WUR-part 1402. As an example, in a case that the number of processing points of the IDFT is 64, subcarriers are allocated in a range where the index is −6 to 6, and a baseband signal after the IDFT is made to fall within, for example, 4 MHz. Note that the index 0 is not used as the DC carrier. A value configured to the subcarrier at the time of the WUR signal transmission is not particularly specified, but as an example, at the time of preamble transmission of the L-part, for example, a method using a value of a subcarrier used in the STF or the LTF of the IEEE802.11a, a method using part of a pseudo-random number sequence such as an M sequence, or the like may be used.

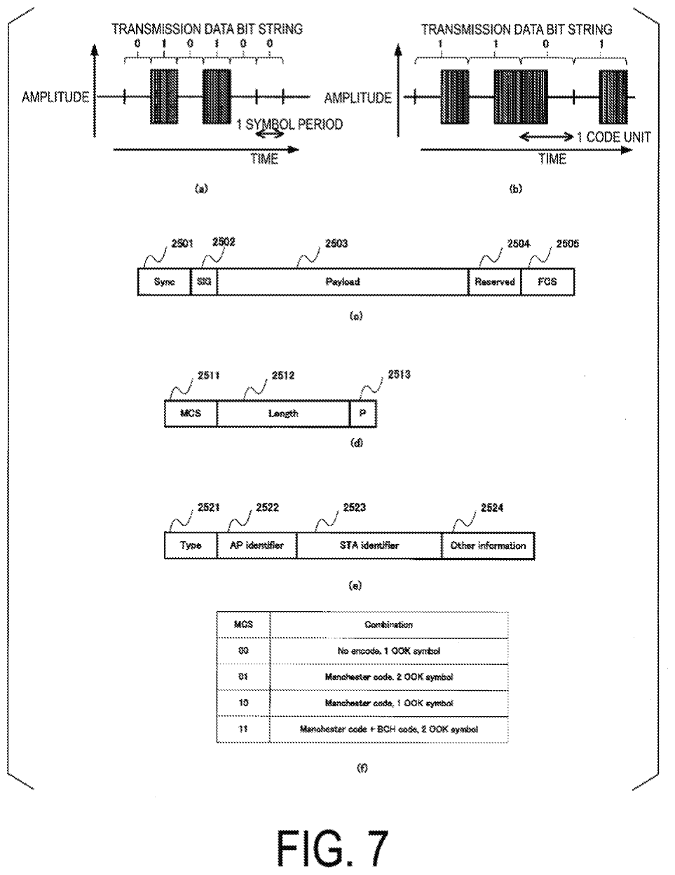

At the station on the reception side, in order to reduce power used at the time of demodulation of the WU radio signal, the WU radio signal is assumed to be in a form which can be subjected to the envelope detection. In the present embodiment, an on-off keying (OOK) modulation scheme is used. In the present embodiment, two coding types of coding with no code (no codes are used) and coding using a Manchester code are used as data coding, but one type of the coding method may be used, and more than two types may be used. An example of the WU radio signal at the time of performing the OOK modulation with using code is illustrated in FIG. 7(a). The modulation symbol uses a prescribed time as a unit, and the presence or absence of an amplitude of the WU radio signal is assigned to a transmission data bit. In the present embodiment, for the amplitude zero, the transmission bit is assumed to be zero, and for a state in which prescribed data are configured to the subcarrier used for transmission and the WU radio signal has the amplitude, the transmission bit is assumed to be one. An example of the WU signal at the time of performing the OOK modulation using the Manchester code is illustrated in FIG. 7(b). Two modulation symbols of the OOK modulation with no code are taken as one code unit, and assumed to be a modulation symbol after coding by the Manchester code. In the present embodiment, a state in which the OOK modulation symbol with no code is allocated in order of 0 and 1 is assumed as the transmission data bit 1 before the coding, and a state in which the OOK modulation symbol with no code is allocated in order of 1 and 0 is assumed as the transmission data bit 0 before the coding. Here, an example has been described in which two OOK symbols are used to transmit 1-bit data, but the Manchester coding may be used such that one OOK symbol is divided into two symbols to cause an OOK symbol having an amplitude of 0 in the first half portion and an amplitude of 1 in the latter half portion to be a transmission data bit of 1, and cause an OOK symbol having an amplitude of 1 in the first half portion and an amplitude of 0 in the latter half portion to be a transmission data bit of 0.

An overview of the WU radio frame structure used for the WUR-part 1402 in FIG. 14(a) is illustrated in FIG. 7(c). In the WU radio frame, a reference numeral 2501 denotes a synchronization part for use in synchronization, and includes the prescribed number and values of OOK modulation symbols. For example, this synchronization part may include the prescribed number of OOK modulation symbols, for example, four or eight OOK modulation symbols, and in a case of four symbols, the transmission data bits may have an OOK symbol sequence of 1, 0, 1, 0. In a case of eight symbols, by using the Manchester code, the transmission data of 1, 0, 1, 0 may be used and the eight OOK symbols in total may be transmitted. A reference numeral 2502 denotes an SIG (SIGnal) field for indicating a Moduration and Coding Scheme (MCS) of a modulation symbol used in a payload portion 2503, a reservation portion 2504, and an FCS 2506 subsequently transmitted and indicating the number of symbols transmitted as the payload portion 2503, the reservation portion 2504, and the FCS 2506. An example of the structure of the SIG field 2502 is illustrated in FIG. 7(d). A reference numeral 2511 denotes an MCS field for specifying an MCS of a portion used after the SIG field 2502, a reference numeral 2512 denotes a Length field for indicating the number of symbols used in a portion after the SIG field 2502, and a reference numeral 2513 denotes a parity field representing parity information of the MCS field 2511 and the Length field 2512. The MCS field 2502 may indicate, as an example, a combination of different cases such as a case of using the OOK modulation with no code, a case of using two OOK modulations using the Manchester code for a 1-bit information bit, and a case of using one OOK modulation using the Manchester code for a 1-bit information bit. The MCS may include a case of using a code other than the Manchester code, or may include a case that another code is combined with the Manchester code. An example of this combination is illustrated in FIG. 7(f). In this example, the MCS of “00” indicates a case that a 1-bit transmission bit is transmitted with one OOK symbol with no code, the MCS of “01” indicates a case that a 1-bit transmission bit is transmitted with two OOK symbols using the Manchester code, the MCS of “10” indicates a case that a 1-bit transmission bit is transmitted with one OOK symbol subjected to the Manchester coding, and the MCS of “11” indicates a case that one bit of the transmission bit subjected to BCH coding is transmitted with two OOK symbols. The Length field 2512 may use the number of information bits to be transmitted rather than the number of transmission symbols. In this case, it is possible to obtain the number of transmission symbols by using the MCS indicated by the MCS field 2511. The number of bits of the parity information included in the parity field 2513 is not particularly specified, but a parity of 1 bit to 4 bits may be used. The Cyclic Redundancy Check (CRC) code using x+1 as the generator polynomial in the case of 1 bit and x\hat{ }4+x+1 as the generator polynomial in the case of 4 bits may be utilized.

Next, an example of the structure of the payload portion 2503 is illustrated in FIG. 7(e). A reference numeral 2521 denotes a Type field representing a type of the WU radio packet, a reference numeral 2522 denotes an AP identifier field for identifying an access point (AP) transmitting the WU radio packet, a reference numeral 2523 denotes an STA identifier field for identifying a station (STA) to which the WU radio packet is transmitted, and a reference numeral 2524 denotes another information field, corresponding to the type of the Type field 2521, for storing information to be used. The reference numeral 2504 denotes the reservation portion for including information not included in the payload portion 2503 in the WU radio packet, and the content of the transmission bits included therein is not particularly defined. Additionally, the reservation portion 2504 may not be included in the WU radio packet. A reference numeral 2505 denotes the Frame Check Sequence (FCS) field that includes information for detecting a reception error of the payload portion 2503 and the reservation portion 2504, and as an example, a CRC code of 16 bits in length may be used.

Since the information speed of the WU radio packet is low, a required transmission time increases depending on the configured MCS, and the radio medium is occupied for a long period of time. In a case that the time during which the radio medium is occupied is desired to be shortened, the number of transmission bits included in the payload portion 2503 and the reservation portion 2504 may be limited depending on the configured MCS such that a transmission symbol having a length greater than or equal to a prescribed length cannot be configured in the Length field 2512 of the SIG field 2502. For example, in a case that the MCS illustrated in FIG. 7(f) is 01, the number of transmission symbols required to transmit the 100-bit transmission bits is 200, and in a case that the MCS is 11, since the number of transmission bits is further doubled in a case of applying the BCH code, the number of transmission symbols required is 400. As an example of a case of limiting the number of transmission symbols to be used for transmission of the payload portion 2503 and the reservation portion 2504, with the assumption that the maximum number of transmission symbols is configured to 400, the maximum number of transmission bits is 400 in a case that the MCS is 00, the maximum number of transmission bits is 200 in a case that the MCS is 01, the maximum number of transmission bits is 400 in a case that the MCS is 10, and the maximum number of transmission bits is 100 in a case that the MCS is 11.

In the operation described above, by configuring the MCS at the time of transmitting the payload portion 2503 and the reservation portion 2504, efficient transmission of the WU radio packet can be achieved.

### Third Embodiment

In a case that a WU radio non-compliant wireless LAN apparatus receives the WU radio packet illustrated in FIG. 14(a), a value of the SIG field included in the L-part 1401 may cause the apparatus to shift, in some cases, to a standby state regardless of a value of the Duration field indicated in the SIG field at the time of receiving the WUR-part 1402. The shift to the standby state is caused because of the following reason. As described in the IEEE802.11 specification (NPL 1), a wireless LAN apparatus is required to cause the MCS indicated by the SIG field to be 6 Mbps at the time of HT PHY transmission. A wireless LAN apparatus, which receives the transmission packet transmitted by using HT PHY, attempts, after demodulation of the SIG field, demodulation of the HT-SIG field allocated immediately after the SIG field, and in a case that the demodulation of the HT-SIG field is failed, the wireless LAN apparatus shifts to the standby state regardless of the value in the SIG field. In a case that there are wireless LAN apparatuses that shift to the standby state regardless of the value of the SIG field, packets transmitted by those wireless LAN apparatuses may cause interference in the WUR-part 1402, and the WU radio non-compliant wireless LAN apparatus receiving a WU radio packet may fail to receive the WU radio packet.

To solve this problem, in the SIG field (or RATE field) included in the L-part 1401 to be transmitted at the time of transmitting the WU radio packet, by configuring the MCS to a value other than 6 Mbps, for example 9 Mbps or 12 Mbps, and by configuring a value of the Length field included in the L-part 1401 to a value based on the MCS configured in the SIG field of the L-part 1401, the L-part 1401 added to the WU radio packet is caused to be equivalent to the L-part 1401 transmitted from an OFDM PHY wireless LAN apparatus, making it possible to prevent the WU radio non-compliant wireless LAN apparatus from shifting to the standby state regardless of the value of the SIG field in a case of receiving the WU radio packet.

The operation described above prevents the WU radio non-compliant wireless LAN apparatus from shifting to the standby state, in a case of receiving the WU radio packet, regardless of the value of the SIG field, and makes it possible to improve utilization efficiency of the radio medium.

### Common to All Embodiments

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

One aspect of the present invention is applicable to radio communication apparatuses.

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1001 Access point
1002, 1003 Station
1501, 1701 Synchronization part
1502, 1702 MCS field
1503, 1703 Terminal identifier field
1504, 1704 Counter field
1505, 1705 Reservation field
1506, 1706 FCS field
1511 BSS color field
1512 Association identifier field
1513 Partial AID field
1401, 1801 Legacy part
1402, 1802-1 to 1802-6 WU radio part
901 to 906 WU radio signal
1201, 1310 Preamble generation unit
1202, 1302 Transmission data control unit
1203, 1303 Mapping unit
1204, 1304 IDFT unit
1205, 1305 P/S converting unit
1206, 1306 GI addition unit
1207, 1307 D/A converting unit
1208, 1308 Transmission RF unit
1209, 1309 Antenna switching unit
1210, 1310 Antenna unit
1211, 1311 Reception RF unit
1212, 1312 A/D converting unit
1213, 1313 Symbol synchronization unit
1214, 1314 S/P converting unit
1215, 1315 DFT unit
1216, 1316 De-mapping unit
1217, 1317 Reception data control unit
1218 DS controller
1219, 1319 Controller
1318 Application IF unit
1320 LPF unit
1321 Envelope detection unit
1322 Synchronization unit
1323 Demodulation unit

1. An access point apparatus for connecting and performing radio communication with multiple station apparatuses, the access point apparatus comprising:
a transmission RF unit configured to transmit a wireless LAN signal and a wake-up radio signal;
a reception RF unit configured to perform a carrier sense; and
a controller configured to control a transmit signal and a received signal,
wherein the controller configures the transmission RF unit to include information that indicates a transmission period of the wake-up radio signal in the wireless LAN signal.

2. The access point apparatus according to claim 1,
wherein the controller configures the transmission RF unit to transmit each of the wireless LAN signal and the wake-up radio signal, by using a different radio channel among radio channels.

3. The access point apparatus according to claim 2,
wherein the controller configures the transmission RF unit to transmit the wireless LAN signal and the wake-up radio signal, by using adjacent radio channels among radio channels.

4. The access point apparatus according to claim 2,
wherein the controller configures information common to Duration information written in an SIG field included in the wireless LAN signal and Duration information written in an SIG field included in the wake-up radio signal.

5. The access point apparatus according to claim 4,
wherein in a case that a legacy part including the SIG field is transmitted on a wake-up radio channel at a time of transmitting the wake-up radio signal, the controller configures, in the SIG field of the legacy part, a signal resulting from phase rotation of a signal including the SIG field included in the wireless LAN signal.

6. The access point apparatus according to claim 4,
wherein the controller configures, in the wireless LAN signal, a signal resulting from phase rotation of the wake-up radio signal.

7. The access point apparatus according to claim 2,
wherein the transmission RF unit simultaneously transmits the wireless LAN signal wake-up radio signal, and
the controller, prior to transmitting the wireless LAN signal, uses the reception RF unit to perform a carrier sense only during a first period and a period configured by a random back-off operation on a radio channel for transmitting the wireless LAN signal, and perform a carrier sense from a point of time, which is a second period earlier than a point of time when the first period and the period configured by the random back-off operation end, on a radio channel for transmitting the wake-up radio signal.

8. The access point apparatus according to claim 2,
wherein the transmission RF unit simultaneously uses at least two radio channels at the time of a transmission, and
in a case of the transmission in which the at least two radio channels are used,
the controller controls the transmission RF unit and switches to at least one of options of whether to transmit the wake-up radio signal on one of the radio channels and transmit the wireless LAN signal on a radio channel other than the one of the radio channels on which the wake-up radio signal has been transmitted, and whether to transmit the wireless LAN signal by using all of the radio channels.

9. The access point apparatus according to claim 2,
wherein the transmission RF unit transmits a radio signal including information that indicates a change of a radio channel on which the wake-up radio signal is to be transmitted on the radio channel on which the wake-up radio signal is to be transmitted.

10. (canceled)

11. (canceled)

12. A station apparatus for connecting and performing radio communication with an access point apparatus, the station apparatus comprising:
a reception RF unit configured to include a function to receive a wireless LAN signal and a wake-up radio signal, and a function to perform a carrier sense; and
a controller configured to control a transmit signal and a received signal,
wherein the controller controls the reception RF unit to change, in a case that the wake-up radio signal addressed to the station apparatus is received, a radio channel on which the carrier sense is performed to a radio channel on which the wireless LAN signal is received.

13. The station apparatus according to claim 12,
wherein the reception RF unit receives, from the access point apparatus, a signal including information for indicating that the radio channel on which the wake-up radio signal is transmitted is to be changed, and
the controller controls the reception RF unit to change, based on the information for indicating that the radio channel is to be changed, a radio channel that starts a reception operation to receive the wake-up radio signal.

14. A communication method of an access point apparatus for connecting and performing radio communication with multiple station apparatuses, the communication method comprising the steps of:
transmitting a wireless LAN signal and a wake-up radio signal;
receiving to perform a carrier sense; and
controlling a transmit signal and a received signal,
wherein, in the controlling, the transmitting is configured to include information that indicates a transmission period of the wake-up radio signal in the wireless LAN signal.
